(19) United States
(12) Patent Application Publication
(10) Pub. No.: US 2009/0225365 A1
(43) Pub. Date: Sep. 10, 2009

(54) INFORMATION PROCESSING APPARATUS, IMAGE PROCESSING APPARATUS, METHOD FOR CONTROLLING INFORMATION PROCESSING APPARATUS, METHOD FOR CONTROLLING IMAGE PROCESSING APPARATUS, AND PROGRAM

(75) Inventor: Takeshi Hayakawa, Kawasaki-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/399,782

(22) Filed: Mar. 6, 2009

(30) Foreign Application Priority Data
Mar. 7, 2008 (JP) 2008-058167

(51) Int. Cl. G06F 15/00; H04N 1/04; G06F 17/00; G06F 3/048; G06K 15/00

(52) U.S. Cl. 358/1.15; 358/474; 715/224; 358/1.18; 715/772

(57) ABSTRACT

An information processing apparatus includes a first storage unit configured to store a plurality of part formats and a form format, a second storage unit configured to store role-visualizing format correspondence information, a determination unit configured to, in response to an instruction for outputting a form corresponding to the form format, determine which part format is to be visualized and output according to role information of a designated user based on the role-visualizing format correspondence information, an embedding data generation unit configured to generate data to embed including data generated by encoding the role-visualizing format correspondence information according to a specific coding system, and a form output data generation unit configured to generate form output data by embedding the data generated by the embedding data generation unit by merging the part formats to be visualized and output determined by the determination unit.

### BACKGROUND OF THE INVENTION

1. Field of the Invention

The present invention relates to an information processing apparatus and an image processing apparatus configured to output a form by using a form format, a method for controlling the information processing apparatus, a method for controlling the image processing apparatus, and a program.

2. Description of the Related Art

A conventional form application uses a layout (a format), which is previously provided and functions as a base format of a form, and generates an output product including data in the layout according to an output instruction.

A form application may manage a large number of forms. Such a form application may manage a form layout as a form part (a part format) and generate a combined form including a plurality of such part formats. In using such a conventional form application, in outputting a form, it is necessary that a user designate a form to be used, among the large number of forms managed by the form application.

Japanese Patent Application Laid-Open No. 10-207969 primarily discusses a method that allows a user to instruct a form to be used via an interface, with which the user can directly input an operation and setting via a graphic user interface (GUI).

If a conventional system discussed in Japanese Patent Application Laid-Open No. 10-207969 is used, in outputting a form, it may be necessary for the user to select and designate a form to be used from among the large number of forms managed therein. In most cases, the user inputs an instruction via an interface that allows the user to input the instruction and a setting primarily via a GUI.

### SUMMARY OF THE INVENTION

According to an aspect of the present invention, an information processing apparatus including a first storage unit configured to store a plurality of part formats and a form format including a combination of the part formats is provided. A second storage unit configured to store role-visualizing format correspondence information, which defines a part format included in the form format, which is to be visualized and output, with respect to role information about each user is also provided. A determination unit configured to, in response to an instruction for outputting a form corresponding to the form format, determine which part format is to be visualized and output according to role information of a designated user based on the role-visualizing format correspondence information is included in the information processing apparatus. An embedding data generation unit configured to generate data to be embedded including data generated by encoding the role-visualizing format correspondence information according to a specific coding system is provided. A form output data generation unit configured to generate form output data by embedding the data generated by the embedding data generation unit in a format generated by merging the part formats to be visualized and output determined by the determination unit is also provided.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the present invention.

FIG. 1 illustrates an exemplary configuration of a system according to an exemplary embodiment of the present invention.

FIG. 2 illustrates an exemplary configuration of a personal computer (PC) that can be used as each of client PCs, a hypertext transport protocol (HTTP) server, and a web application server illustrated in FIG. 1 according to an exemplary embodiment of the present invention.

FIG. 3 illustrates an exemplary module configuration according to an exemplary embodiment of the present invention.

FIG. 4A illustrates an example of a content management method executed by a content management application according to an exemplary embodiment of the present invention.

FIG. 4B illustrates an example of a content management method executed by a content management application according to an exemplary embodiment of the present invention.

FIG. 5 illustrates an example of a form registration method and a form management method according to an exemplary embodiment of the present invention.

FIG. 6 illustrates an exemplary form management database schema according to an exemplary embodiment of the present invention.

FIG. 7 is a flow chart illustrating exemplary form output definition generation processing according to an exemplary embodiment of the present invention.

FIG. 8A is a flow chart illustrating exemplary form output processing according to an exemplary embodiment of the present invention.

FIG. 8B illustrates exemplary form output processing according to an exemplary embodiment of the present invention.

FIG. 9A illustrates an example of a form according to an exemplary embodiment of the present invention.

FIG. 9B illustrates an example of a form according to an exemplary embodiment of the present invention.

FIG. 10 is a flow chart illustrating exemplary form output definition generation processing according to an exemplary embodiment of the present invention.

FIG. 11 is a flow chart illustrating exemplary processing for outputting a plurality of forms according to an exemplary embodiment of the present invention.

FIG. 12 illustrates an example of a form including a data area according to an exemplary embodiment of the present invention.

FIG. 13 is a flow chart illustrating exemplary processing for outputting a form including a data area according to an exemplary embodiment of the present invention.

FIG. 14 illustrates an example of a database schema of a role, a work item, and a visualizing format according to an exemplary embodiment of the present invention.

FIG. 15 illustrates an example of a form that includes and processes a data area and a part format according to an exemplary embodiment of the present invention.

FIG. 16 is a flow chart illustrating exemplary processing for changing a form to be output according to a role according to an exemplary embodiment of the present invention.

FIG. 17A is a flow chart illustrating an example of processing in step S1608 in FIG. 16 for acquiring an image, a text, and data, which are to be embedded in a form, according to an exemplary embodiment of the present invention.

FIG. 17B illustrates an example of processing in step S1608 in FIG. 16 for acquiring an image, a text, and data, which are to be embedded in a form, according to an exemplary embodiment of the present invention.

FIG. 18 is a flow chart illustrating an example of processing for using, from an image processing apparatus, a form (a form whose visualizing area has been changed according to a role) that has been output by form output processing (FIG. 16) according to an exemplary embodiment of the present invention.

FIG. 19 is a flow chart illustrating exemplary annotation form output processing in step S1814 in FIG. 18 according to an exemplary embodiment of the present invention.

FIG. 20A is a flow chart illustrating an example of processing in step S1608 in FIG. 16 for acquiring an image, a text, and data, which are to be embedded in a form according to a second exemplary embodiment of the present invention.

FIG. 20B illustrates an example of processing in step S1608 in FIG. 16 for acquiring an image, a text, and data, which are to be embedded in a form according to the second exemplary embodiment of the present invention.

FIG. 21 is a flow chart illustrating an example of processing for using, from an image processing apparatus, a form (a form whose visualizing area has been changed according to a role) that has been output by form output processing (FIG. 20A) according to the second exemplary embodiment of the present invention.

FIG. 22 is a memory map illustrating an example of a storage medium (recording medium) storing various data processing programs that can be read by an information processing apparatus and an image processing apparatus according to an exemplary embodiment of the present invention.

### DETAILED DESCRIPTION OF THE EMBODIMENTS

Various exemplary embodiments, features, and aspects of the present invention will now be herein described in detail below with reference to the drawings. It is to be noted that the relative arrangement of the components, the numerical expressions, and numerical values set forth in these embodiments are not intended to limit the scope of the present invention.

To begin with, a technique that is a premise to an exemplary embodiment of the present invention will be described in detail below. In an exemplary embodiment of the present invention, a system includes a web application server and an image processing apparatus. The web application server includes a form application and a content management application. The form application generates a form. The content management application issues an instruction for outputting a form to the form application.

In the present exemplary embodiment, a “content” refers to electronic data that can be read and processed by an information processing apparatus, such as document data, image data, text data, audio data, video data, and the like.

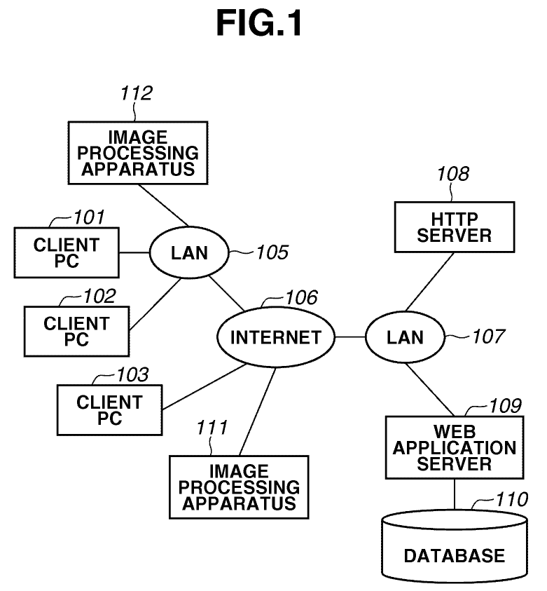

FIG. 1 illustrates an exemplary configuration of the system according to an exemplary embodiment of the present invention.

Referring to FIG. 1, the system includes client PCs 101 through 103, a hypertext transport protocol (HTTP) server (web server) 108, and a web application server (WAS) 109, which are in communication with one another via a network. Furthermore, image processing apparatuses 111 and 112 can access the system via a network.

The client PCs 101 through 103 each execute data communication by HTTP using a web browser. For example, the client PCs 101 through 103 are PCs used by a system administrator in executing a maintenance operation on a content management application or in executing system maintenance processing for correcting user management information.

Local area networks (LANs) 105 and 107 and the Internet 106 are used in the system as the network. The client PCs 101 and 102, connected to the LAN 105, can transmit and receive data to and from other apparatuses on the network via the LAN 105. The client PC 103 is connected to the Internet 106.

The HTTP server (a web server) 108 receives a request transmitted from the client PCs 101 through 103 via the network by HTTP protocol. A number of web application servers are registered on the HTTP server 108. The HTTP server 108 assigns processing to an appropriate web application server according to the content of the request from the client PCs 101 through 103. After receiving the request, the web application server 109 executes the requested processing. Then, the web application server 109 transmits a result of the processing to the client PCs 101 through 103.

The web application server 109 includes the above-described form application and a content management application installed on the web application server 109. A database 110 is connected to the web application server 109. Content data, data associated with the content, information such as an operation history and a processing status, system information such as user/group information, and information for processing and information for processing a form are recorded on the database 110. The HTTP server 108, the web application server 109, and the database 110 are controlled and operate in cooperation with one another as a web database system.

The web application server 109 is connected to the image processing apparatuses 111 and 112 via the LANs 105 and 107 and the Internet 106. The web application server 109 can use functions of the image processing apparatuses 111 and 112 via the network.

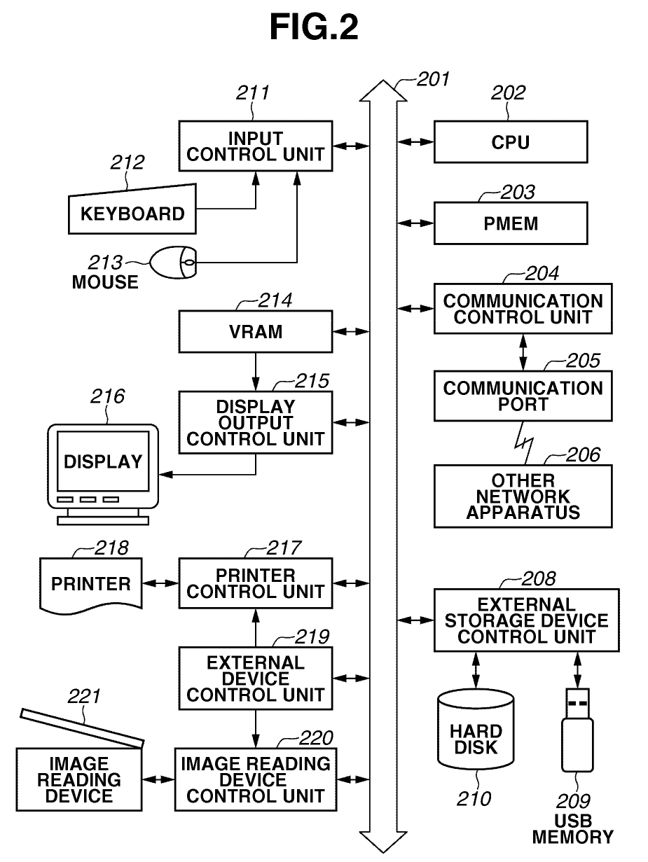

FIG. 2 illustrates an exemplary configuration of a personal computer (PC) that can be used as each of client PCs 101 through 103, the HTTP server 108, and the web application server 109 illustrated in FIG. 1 according to an exemplary embodiment of the present invention. Referring to FIG. 2, a central processing unit (CPU) 202, a program memory (PMEM) 203, a communication control unit 204, and an external storage device control unit 208 are in communication with one another via a system bus 201.

Furthermore, an input control unit 211, a video image memory (video random access memory (VRAM)) 214, a display output control unit 215, a printer control unit 217, an external device control unit 219, and an image reading device control unit 220 are in communication with one another via the system bus 201.

The communication control unit 204 executes control over data input and output via the communication port 205. A signal output from the communication port 205 is transmitted to a communication port of another apparatus 206 on the network via a communication line.

The external storage device control unit 208 controls an access to a universal serial bus (USB) memory 209 and a hard disk drive (HDD) 210, which store a data file.

An input device such as a keyboard 212 and a pointing device such as a mouse 213 are connected to the input control unit 211. An operator issues an instruction on the system by operating the input device.

A display 216 is connected to the video image memory (VRAM) 214 via the display output control unit 215. Furthermore, data displayed on the display 216 is rasterized on the VRAM 214 as bitmap data.

The mouse (pointing device) 213 can be operated by the user to issue an instruction for processing image information via the display 216. More specifically, the user can operate the mouse 213 to arbitrarily move a cursor displayed on the display 216 in X and Y directions and select a command icon displayed in a command menu. Furthermore, the user can operate the mouse 213 to execute an instruction for executing processing and instruct an object of editing and a rendering position.

The CPU 202 selects, loads, and executes a program for executing the processing according to an exemplary embodiment of the present invention from the HDD 210 on the PMEM 203. Furthermore, data input via the keyboard 212 is stored as code information on the PMEM 203, which is a text memory.

The printer control unit 217 is connected with the printer 218 and controls data to be output to the printer 218. The image reading device control unit 220 is connected to an image reading device 221 and controls the operation of the image reading device 221. The external device control unit 219 controls an external device such as the printer 218 and the image reading device (scanner) 221.

Note that in the client PCs 101 through 103 according to an exemplary embodiment of the present invention, components such as the printer 218, the printer control unit 217, the image reading device control unit 220, and the image reading device 221, which are directly connected to the client PC, are not always necessary.

Note that in the present exemplary embodiment, a network such as the LAN is used. However, the present invention is not limited to this. That is, in the present exemplary embodiment, it is also useful if a public line is connected to the communication control unit 204 instead of the communication port 205 and the communication line.

Furthermore, the image reading device control unit 220 and the image reading device 221 can have a similar function as described below regardless of whether the image reading device control unit 220 and the image reading device 221 are separately and independently provided on physically mutually different apparatuses or whether the image reading device control unit 220 includes the image reading device 221 as a single component.

Furthermore, the program stored on the PMEM 203 can be stored on a storage medium such as the HDD 210, which is built in the PC or on an external storage device such as the USB memory 209. In addition, it is also useful if the program is stored on another apparatus connected to the system via the network.

Note that the client PCs 101 through 103 each include a general-purpose web browser (Internet Explorer of Microsoft Corporation) on its storage medium. The CPU 202 loads and executes the program of the web browser from the HDD 210. Thus, a user interface of the present invention may be implemented on the web browser.

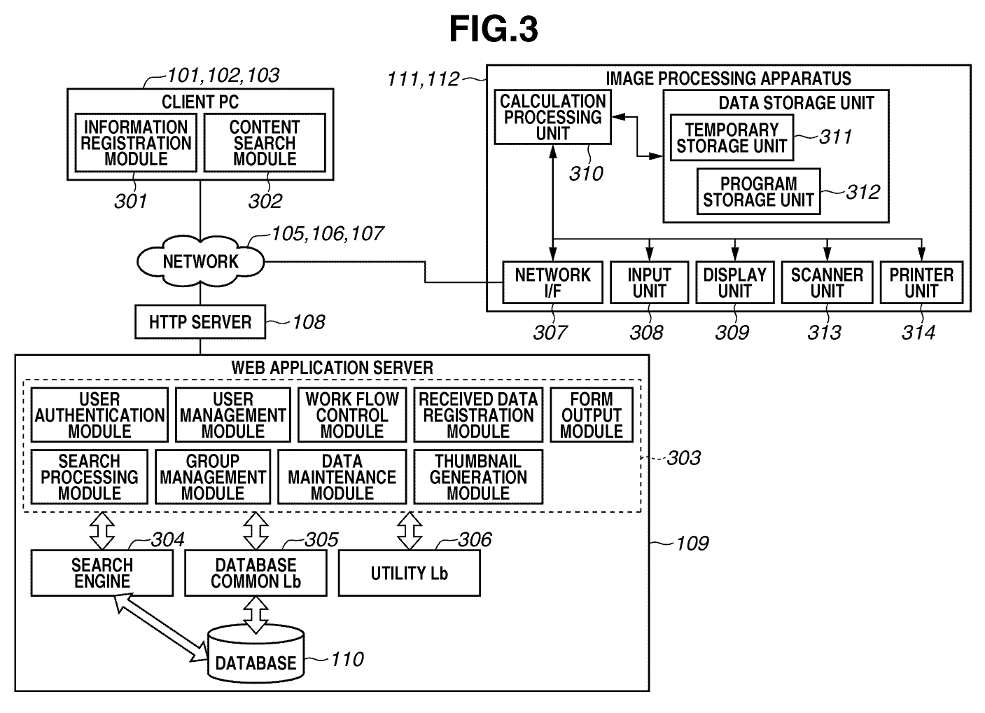

FIG. 3 illustrates an exemplary module configuration according to an exemplary embodiment of the present invention.

Referring to FIG. 3, the client PCs 101 through 103 each include an information registration module 301 and a content search module 302. The information registration module 301 is a module for registering a content such as catalog information and image data on the web application server 109 via the HTTP server 108 and for generating the form that uses the selected data. The content search module 302 is a module for searching for the registered content.

The modules can be previously installed on the storage medium of the PC. However, the present invention is not limited to this. That is, it is also useful if the module is automatically transmitted from the web application server 109 as a plug-in to the web browser as necessary. Note here that the client PCs 101 through 103, the HTTP server 108, and the web application server 109 are mutually different PCs. However, each of the client PCs 101 through 103, the HTTP server 108, and the web application server 109 has the same configuration illustrated in FIG. 2. In this regard, it is not always necessary for the client PCs 101 through 103, the HTTP server 108, and the web application server 109 to include the USB memory 209 and the printer control unit 217, which can be provided as necessary.

Furthermore, the program modules 301 and 302 of the client PCs 101 through 103 are stored on the HDD 210 thereof. The program modules 301 and 302 of the client PCs 101 through 103 are read and executed by the CPU 202. Similarly, the function and the program modules of the web application server 109 are stored on the HDD 210 of the web application server 109. The function and the program modules of the web application server 109 are read and executed by the CPU 202.

The web application server 109 stores a module 303. The module 303 is a module for processing a request having been issued by the client PCs 101 through 103 and received from the HTTP server 108.

The module 303 includes the form application and the content management application described above. In addition, the module 303 includes various functions. The functions of the module 303 include a user authentication function, a user management function, a work flow control function, a received data registration function, a thumbnail generation function, a group management function, a form output function, and a search processing function, for example.

Here, the user authentication function is a function for verifying whether a user who desires to log into the system has authority. The user management function is a function for registering and managing private information (user information). The work flow control function is a function for controlling a work flow. The received data registration function is a function for registering received image data of a form.

The thumbnail generation function is a function for generating a thumbnail of the registered content. The generated thumbnail is stored on the database 110. The group management function is a function for managing a registered group of a user.

The form output function is a function for embedding designated data in a form and outputting the form. The search processing function is a function for searching for the content and executing full-text search processing. The modules are operated to execute processing requested from the client PCs 101 through 103.

In addition to the module 303, the web application server 109 includes a database common library 305 and various utility libraries 306.

The content search processing according to an exemplary embodiment of the present invention is executed by utilizing a search engine 304. The search engine 304 exists in a layer below the search processing function of the module 303. The search engine 304 refers to an engine for searching for a content related with input text data by generally executing “full-text search”, “textual search”, and “image search”.

The full-text search and the textual search can be executed in searching for a specific element of a document such as a heading or an author or searching for all information included in a document. In the present exemplary embodiment, the search engine 304 can use either of the methods (or similar method).

The image search is a search method for searching for a content based on a caption of a content or a text surrounding a content. In this regard, previously collected and stored data may be used in image search. In executing the image search, the search engine 304 can use either of the above-described methods (or similar method).

In an exemplary embodiment of the present invention, it is significant and useful that the search engine 304 includes a function for searching for a content related with input text data but the algorithm or method for searching for the content is not limited to a specific method.

The search engine 304 transmits a result of the search, the number of hits, and the search score of each executed search according to a request from an upper layer. The above-described information is equivalent to the information obtained by executing the content search. In this regard, in a first exemplary embodiment of the present invention, the search score is particularly used.

Furthermore, the database 110 may be used according to the type of search engine 304. In executing the search processing, it is also useful if a plurality of search engines are used according to the type and purpose of the search. Note that the database 110 is provided on the HDD 210 of the web application server 109.

The image processing apparatus 111 or 112 includes various modules. In the following description, those significant and useful in the present invention are described.

The image processing apparatus 111 or 112 receives an access from the client PC and the web application server via the network. Furthermore, the image processing apparatus 111 or 112 can transmit the scanned image to the PC.

A network I/F 307 is an interface between the image processing apparatus 111 or 112 and external devices. The image processing apparatus 111 or 112 and external devices are in communication with one another via the network. The image processing apparatus 111 or 112 may be provided on the same network as the networks 105 through 107 via the network I/F 307.

Furthermore, a user can input an instruction according to the content displayed on the display unit 309 to the image processing apparatus 111 or 112 via an input unit 308.

A calculation processing unit 310 of the image processing apparatus 111 or 112 has a function similar to that of the CPU 202 of the PC. Furthermore, a program that instructs the calculation processing unit 310 to execute processing is stored on the temporary storage unit 311 and the program storage unit 312. The scanner unit 313 reads image data of a document (a form, for example). The printer unit 314 prints and outputs the read document (form).

Now, the content management method executed by the content management application included in the module 303 illustrated in FIG. 3 will be described in detail below.

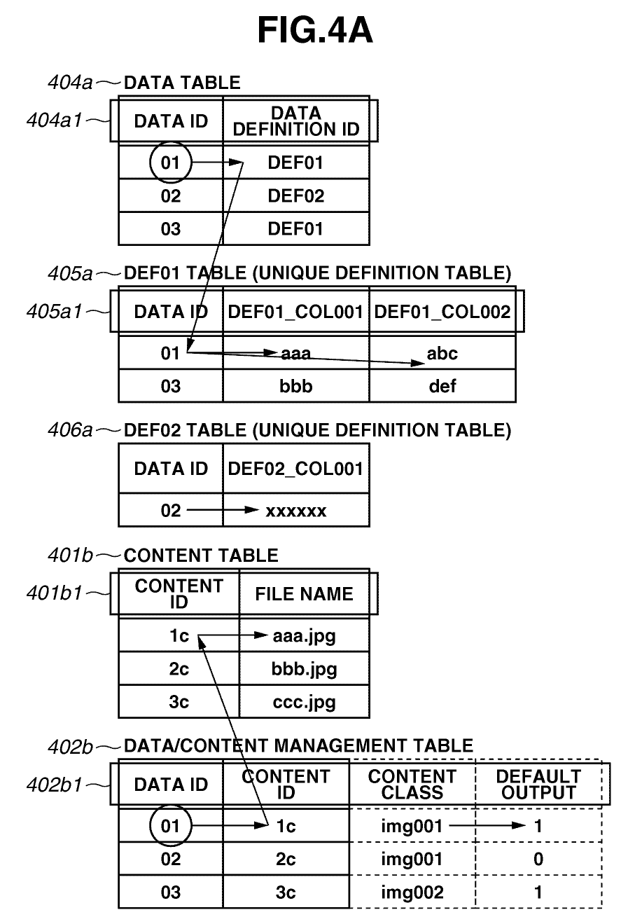

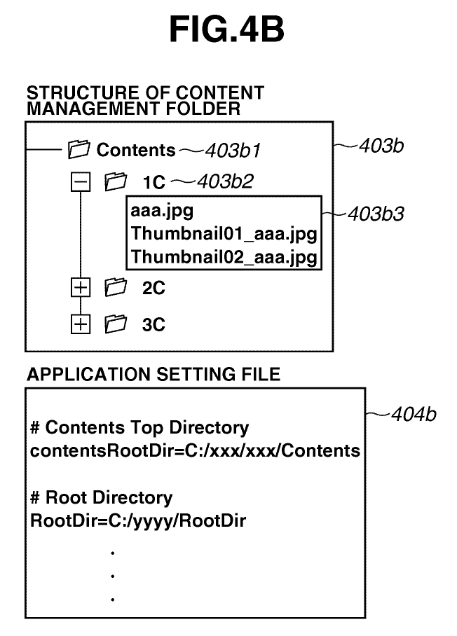

FIGS. 4A and 4B each illustrate an exemplary content management method executed by the content management application according to an exemplary embodiment of the present invention.

The content management application includes various user interface (UI) (not illustrated), such as a search screen, a data display screen, and a data input screen. The information stored in the database 110 can be transmitted to the Internet via the web application server 109. That is, the UIs may be displayed and operated via the web browser of the client PC. Furthermore, the content management application can register the text or numerical data associated with a content to be registered via the UI.

Referring to FIG. 4A, database schemas 404a, 405a, and 406a each store a text or numerical data. Hereinbelow, the schema is referred to as a “data definition”. The database is used by the content management application and is provided in the database 110.

The database 110 includes a data table 404a and unique definition tables 405a and 406a. The unique definition tables 405a and 406a are generated according to a value stored in the data table 404a. In an exemplary embodiment of the present invention, two tables “DEF01” and “DEF02” are generated.

The data definition can be arbitrarily defined and generated by the user (a system administrator or the like) by determining a data definition identification (ID).

The data table 404a manages the generated data definition according to a unique ID and a data definition ID stored therein in association with each other according to a table definition 404a1. As illustrated in FIG. 4A, the data table 404a manages three types of definitions.

The unique definition table 405a corresponds to the data definition ID “DEF01” in the data table 404a. The data definition ID “DEF01” is used as the table name of the unique definition table 405a. The unique definition table 405a manages an item defined in the data definition. The item is generated when the user (the system administrator or the like) defines the data definition ID. Note that the item can be added, deleted, or corrected after being defined.

In the example illustrated in FIG. 4A, two items, “DEF01_COL001” and “DEF01_COL002” are used. The items are hereinafter simply referred to as “data item keys”. The type of the item can be arbitrarily determined. For example, a numerical value, a text string, and the date and time can be used. In this regard, for example, the item “DEF01_COL001” can be defined as a text string item indicating a name of the data while the item “DEF01_COL002” can be defined as the date and time item indicating the date and time of processing the data. Note that in the example illustrated in FIG. 4a, the unique definition table 405a manages two values (“aaa” and “abc”) corresponding to a data ID “01” and two values (“bbb” and “def”) corresponding to a data ID “03”.

Now, processing for extracting data executed with the above-described configuration is described in detail below.

When the user has designated the data ID “01”, the content management application acquires a data definition ID corresponding to the data ID “01” from the data table 404a (in the example illustrated in FIG. 4A, the data definition ID “DEF01” is acquired). That is, the data ID “01” is managed in the table having a table name “DEF01”.

Then, the content management application refers to the unique definition table 405a corresponding to the table name “DEF01” and acquires values of two items “DEF01_COL001” and “DEF01_COL002” by using the data ID “01” as a key. In the example illustrated in FIG. 4a, the content management application acquires “aaa” and “abc”. In the above-described manner, the content management application can acquire a value associated with the data by designating the data ID.

The unique definition table 406a corresponds to a data definition ID “DEF02” in the data table 404a. The data definition ID “DEF02” is set as the table name of the unique definition table 406a. The unique definition table is generated according to the data definition ID. Accordingly, the unique definition tables 405a and 406a have the same configuration. However, the item thereof may differ with respect to each data definition. In this regard, for example, the unique definition table 406a is referred to when the user has designated the data ID “02”.

Now, a content management database according to an exemplary embodiment of the present invention will be described in detail below.

The content management database includes schemas 401b and 402b. The database is used by the content management application and is provided in the database 110. More specifically, the database includes a content table 401b and a data/content management table 402b. A value of each table is registered every time a content is registered. When the user has designated a file corresponding to the content to be registered, the content management application adds a value to each table.

The content table 401b manages the generated content according to a unique ID and a file name stored therein in association with each other according to a table definition 401b1. As illustrated in FIG. 4A, three content IDs “1c”, “2c”, and “3c” are registered and managed in the content table 401b.

The data/content management table 402b manages the relationship between the registered content and the data. The data/content management table 402b includes the data ID in the data table 404a and the content identifier in the content table 401b. In addition, the data/content management table 402b includes items such as a content class and a default output. Note that the items such as the content class and the default output are not always necessary in managing data and its content. Accordingly, the detailed description thereof will be omitted here.

Now, content extraction processing executed with the above-described configuration according to an exemplary embodiment of the present invention will be described in detail below.

When the data ID “01” is designated by the user, the content management application acquires the corresponding content ID from the data/content management table 402b. In the present exemplary embodiment, the content ID “1c” is acquired. That is, the data ID “01” corresponds to the content ID “1c”.

Then, the content management application acquires a corresponding file name from the content table 401b by using the content ID “1c” as a key. In an exemplary embodiment of the present invention, a file name “aaa.jpg” is identified. In the above-described manner, the content management application can acquire the associated content by referring to the data ID.

In the example illustrated in FIG. 4B, a content management folder 403b stores the content to be managed. In an exemplary embodiment of the present invention, the content is stored on a folder that the content management application can refer to.

The content management folder 403b has a hierarchical structure. More specifically, the content management folder 403b includes a root directory 403b1, which includes a sub folder 403b2 therebelow. Furthermore, the sub folder 403b2 stores content files 403b3.

Note that the root directory 403b1 is determined by the content management application. The determination is executed according to a description in an application setting file 404b. The application setting file 404b will be described in detail later below.

Furthermore, the content ID is used as the folder name of the sub folder 403b2. More specifically, the file corresponding to the content ID is stored in the folder named after the content ID.

The content files 403b3 includes an original file, which is a registered content and having been designated at the time of the registration. Note that it is also useful if a related file such as a thumbnail for display is stored in addition to the original file.

The setting file 404b is included in the content management application. The application setting file 404b includes a value unique within the system, which is referred to at the time of activating the content management application or executing processing with the content management application.

Note that the user (the system administrator) can edit the value described in the application setting file 404b. In the present exemplary embodiment, a path to the root directory for storing a content file is described in the application setting file 404b.

As described above, the content management application manages a content as a technique premise to the present invention.

Now, a form registration and management method executed by the content management application as a method premise to the present invention will be described in detail below.

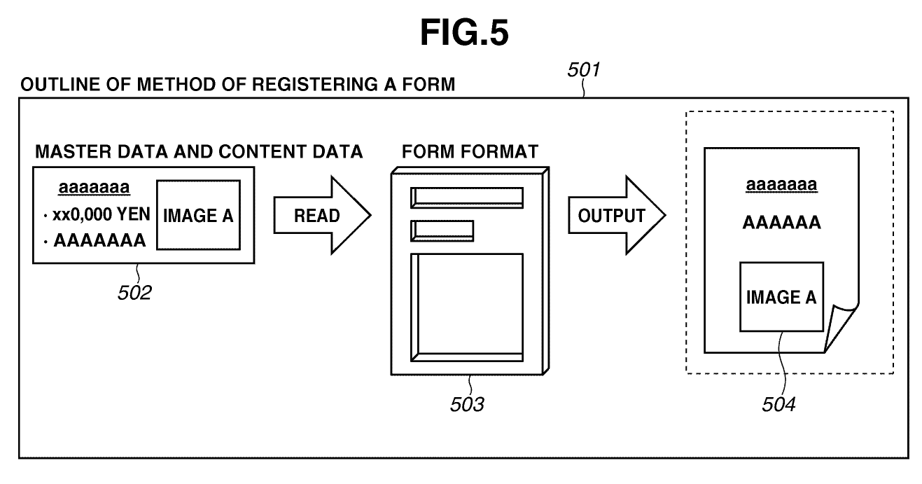

FIG. 5 illustrates the outline of a form registration method and a form management method executed by the content management application according to an exemplary embodiment of the present invention.

Referring to FIG. 5, the content management application performs the following processing described in the outline of the form registration method 501. In processing 502, the content management application designates a content associated with the data. In processing 503, the content management application selects a form to be output. In processing 504, the content management application outputs the form including the data designated in processing 502 and the content embedded therein. Note that the form can be output as an electronic file.

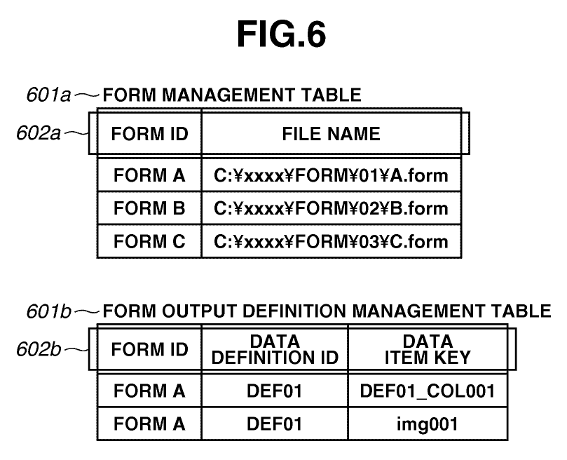

FIG. 6 illustrates an exemplary form management database schema according to an exemplary embodiment of the present invention.

Referring to FIG. 6, schemas 601a and 601b are included in a database for managing a form. The database is used by the content management application and is provided in the database 110.

The form management table 601a manages the form used by the content management application. When a form is registered, the content management application issues a unique ID (a form ID). Then, the content management application associates the form ID with the form and manages the form and the corresponding ID by using a table definition 602a.

The form output definition management table 601b manages a data definition ID and a data item key corresponding to the form ID. Here, the data definition ID and the data item key are similar to those illustrated in FIGS. 4A and 4B. Note that which data definition ID and data item key are to be associated with which form (form ID) is designated by the user in registering the form via the UI (not illustrated).

Note that according to the type of form, the user can designate a plurality of data item keys. More specifically, a plurality of data item keys is associated with a form because a form usually includes two or more areas.

In the form output definition management table 601b in FIG. 6, a data item key “DEF01_COL001” of the data definition “DEF01” and another data item key “img001”, which indicates an image area, are associated with the form ID “form A”.

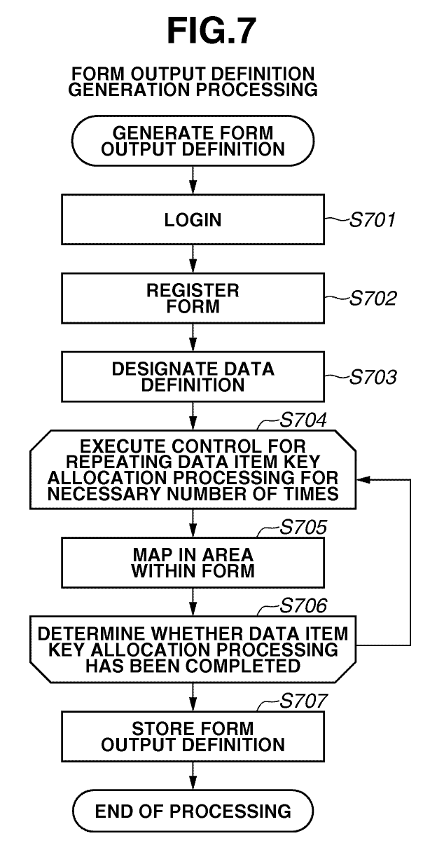

Now, processing for registering a form according to an exemplary embodiment of the present invention will be described in detail below with reference to FIG. 7.

FIG. 7 is a flow chart illustrating exemplary form output definition generation processing according to an exemplary embodiment of the present invention. Note that the processing executed according to the flow chart in FIG. 7 is implemented with the CPU 202 of the web application server 109 by loading and executing the content management application program on the PMEM 203 from the HDD 210. That is, each step in the flow chart in FIG. 7 is executed with the CPU 202 of the web application server 109 according to a command received from the content management application program stored on the PMEM 203. Hereinbelow, it is supposed that the content management application simply executes the processing for easier understanding.

Referring to FIG. 7, in step S701, after receiving a request for logging into the content management application from a user, the content management application starts login processing. Note here that the user issues the login request via the web browser of the client PC 101 through 103.

In step S702, the content management application receives a user operation for registering a form via the web browser of the client PC 101 through 103. In registering a form, the user first designates a unique form identifier (“form A”, for example) from the client PC and then uploads the form to the web application server 109 together with a form format file (“A.form”, for example).

In response to the user operation, the content management application stores the above-described uploaded form format file (“A.form”) in an area (in an area “C:¥xxx¥FORM¥01¥”, for example) of the HDD 210 of the web application server 109. In addition, the content management application links the form format file stored in the above-described manner with the designated form ID. Then, the content management application stores the file and the form ID on a memory as form management data.

In step S703, the content management application receives a user designation of data to be associated with the form designated in step S702 (the designation of the data definition) via the web browser of the client PCs 101 through 103. Note that in designating a data definition, the user selects and designates the data definition from among data definition IDs (“DEF01”, for example) and data definition items (“DEF01_COL001”, for example), which have been previously registered in the data table 404a (FIG. 4A). Furthermore, in designating a data definition, it is also useful if the user selects and designates a content class (“img001”, for example) in the data/content management table 402b.

In steps S704 through S706, the content management application performs control for executing processing in step S705 for the necessary number of times (equivalent to the number of areas of the form in which data is to be embedded).

In step S705, the content management application assigns the data item key of the data definition designated in step S703 in the data embedding area of the form. Then, the content management application stores the same on the memory as form output definition management data.

Note that the area of the form in which the data is embedded differs with respect to each form. Accordingly, it is also useful if the determination as to whether the loop processing in steps S704 through S706 has been completed is executed according to a user instruction.

After assigning the data item key in steps S704 through S706, the content management application advances to step S707. In step S707, the content management application registers the form management data generated in step S702 in the form management table 601a. In addition, the content management application registers the form output definition management data generated in steps S704 through S706 in the form output definition management table 601b.

That is, the data illustrated in FIG. 6 (the form management table 601a and the form output definition management table 601b) is committed (registered) in the database 110 at this timing. Then, the processing in the flow chart in FIG. 7 ends.

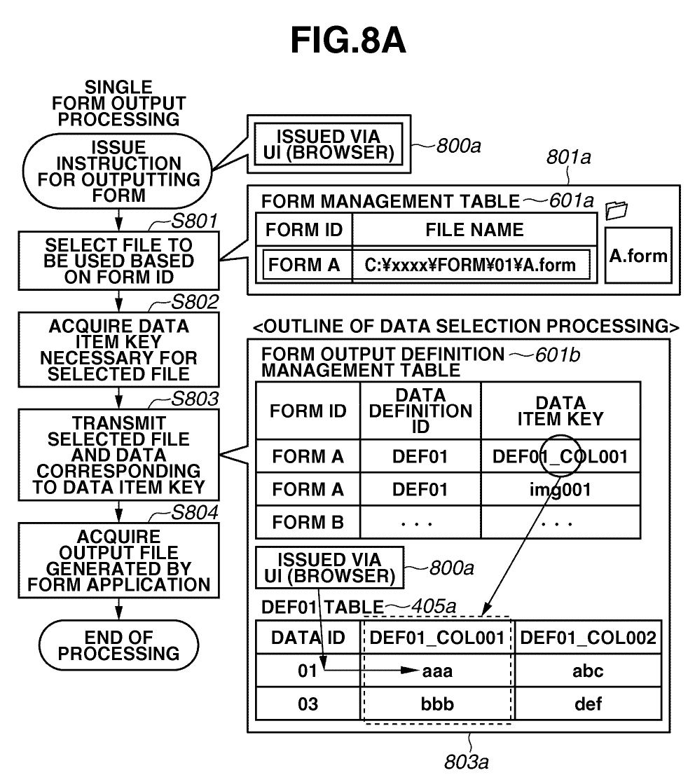

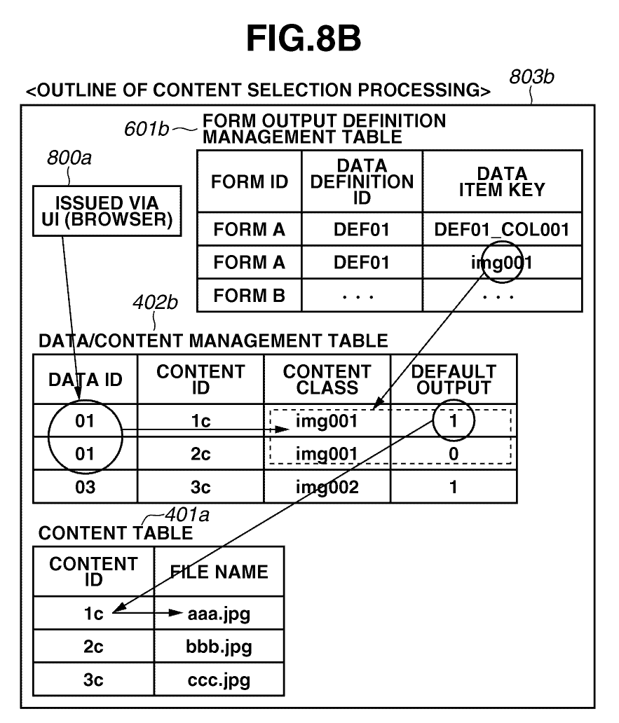

FIGS. 8A and 8B each illustrate exemplary form output processing according to an exemplary embodiment of the present invention. Note that in the form output processing illustrated in FIGS. 8A and 8B, only one form is output. Accordingly, the processing is hereinafter referred to as “single form output processing”. The user issues an instruction for outputting a single form via the web browser.

Furthermore, the processing according to the flow chart in FIG. 8A is implemented with the CPU 202 of the web application server 109 by reading and executing the content management application program on the PMEM 203 from the HDD 210. That is, each step in the flow chart in FIG. 8A is executed with the CPU 202 of the web application server 109 according to a command received from the content management application program stored on the PMEM 203. Hereinbelow, it is supposed that the content management application simply executes the processing for easier understanding.

After receiving an instruction for outputting a single form (including the form ID thereof) via the web browser of the client PC 101 through 103, the content management application starts the processing in the flow chart in FIG. 8A.

In step S801, the content management application refers to the form management table 601a and selects the file to be used according to the form ID designated in the received instruction for outputting the form. More specifically, in processing 801a, the content management application refers to the form management table 601a and determines the file name (directory path) “C:¥xxx¥FORM¥01¥A.form” according to the form ID “form A”. Thus, the content management application verifies and acquires (selects) the corresponding file “A.form”.

In step S802, the content management application refers to the form output definition management table 601b and acquires the data item key corresponding to the form file selected in step S801.

In step S803, the content management application transmits the file selected in step S801 and the data corresponding to the data item key acquired in step S802 to the form application.

Note that the form application is executed on the web application server 109, on which the content management application is executed, and processes the form. The form application is included in the module 303 (FIG. 3). Furthermore, the form application includes an interface for communicating with an external application. The form application can generate electronic data of the form including a value embedded therein by receiving a form file and data to be embedded from the external application.

Here, processing 803a (FIG. 8A) and 803b (FIG. 8B) each illustrate the outline of processing in steps S802 and S803.

Hereinbelow, it is supposed that the form ID of the form whose instruction has been issued from the user is “form A”. In this case, the content management application refers to the form output definition management table 601b and acquires a data definition “DEF01” and data item keys “DEF01_COL001” and “img001”.

Now, processing for selecting data will be described in detail below with reference to a data selection processing outline 803a in FIG. 8A. Suppose here that the data ID selected via web browser (not illustrated) of the client PC on which the user has instructed the data to be output is “01”. In this case, the content management application refers to the unique definition table 405a (FIG. 4A) for the data definition “DEF01” and acquires a value “aaa” corresponding to the data item key “DEF01_COL001”.

Now, exemplary processing for selecting the content according to an exemplary embodiment of the present invention will be described in detail below with reference to a content selection processing outline 803b in FIG. 8B. Referring to FIG. 8B, a value “img001” is a value of a content class of the data/content management table 402b. The data/content management table 402b includes items such as a content class and a default output in addition to the items data ID and content ID. The content class stores information for identifying the type of the content corresponding to the content ID. The default output stores a flag value indicating the content to be output as default.

If the data ID selected via the web browser (not illustrated) of the client PC on which the user has instructed the data to be output is “01”, then it is known from the data/content management table 402b that two content IDs “1c” and “2c” are the IDs for the content corresponding to the data having the data ID “01”. In this case, the content management application refers to the default output value. With respect to the default output value, a value “1” indicates the enabled state (i.e., the default value is used) while a value “0” indicates the disabled state (i.e., the default value is not used).

Here, it is known from the data/content management table 402b that the content ID of the data whose default output value is “1” is “01”. Accordingly, the content management application sets the content ID “01” as the content to be used. Furthermore, with respect to the file of the content to be used, the name of the file of the content to be used can be identified by referring to the content table 401b. That is, the content management application refers to the content table 401b and acquires the name of the file “aaa.jpg” corresponding to the content ID “01”.

Then, the content management application transmits the file “A.form”, the data “aaa”, and the content file “aaa.jpg”, which have been selected in the above-described manner, to the form application.

In step S804, the content management application receives, the electronic file (a portable document format (PDF) file, for example) generated by the form application.

Then, the content management application transmits the electronic file received from the form application in step S804 to the client PC to display the content of the file on the web browser of the client PC. The single form output processing according to an exemplary embodiment of the present invention is executed in the above-described manner.

Now, processing for outputting a form generated by merging a plurality of part formats will be described in detail below.

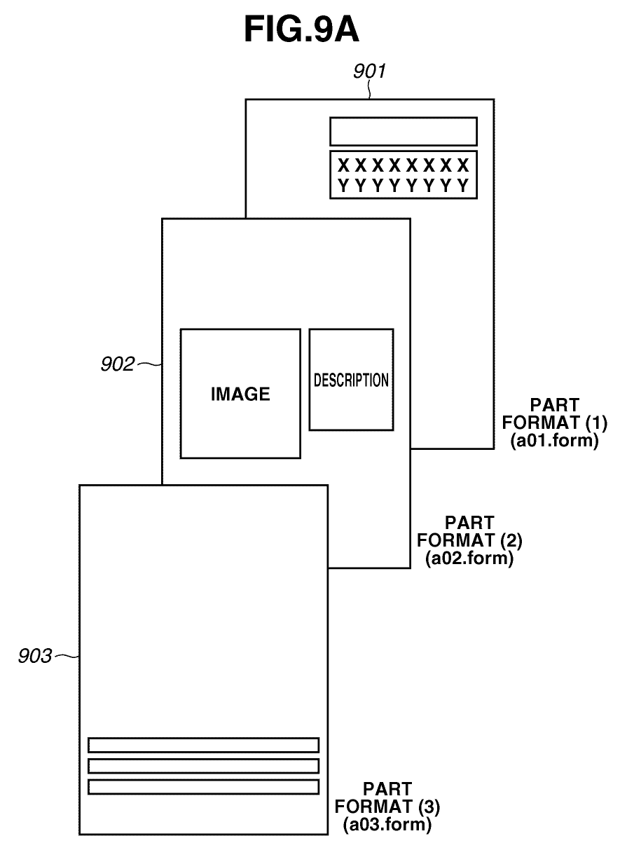

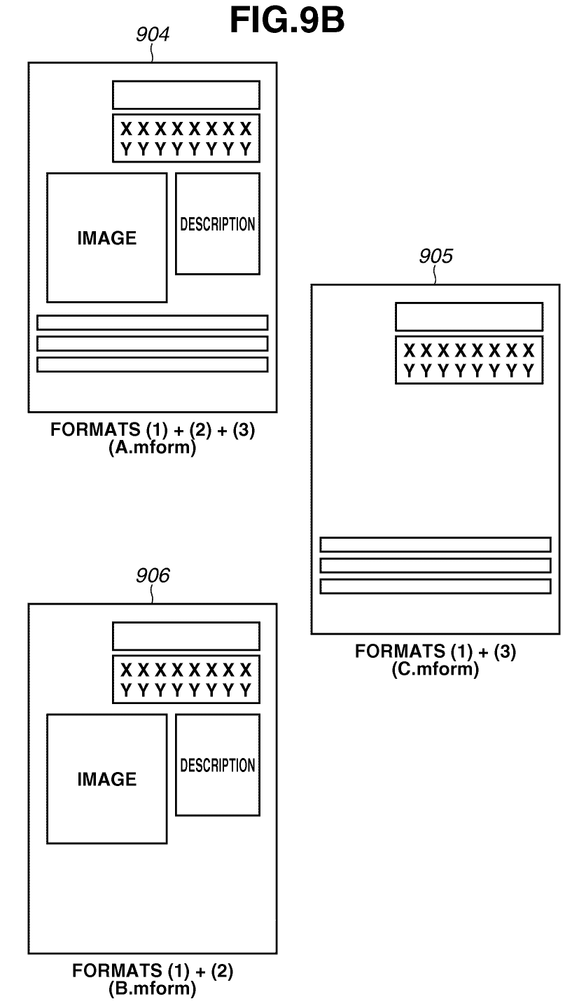

FIGS. 9A and 9B each illustrate an example of the form according to an exemplary embodiment of the present invention.

Referring to FIGS. 9A and 9B, forms 901 through 903 can be processed by the content management application and the form application.

Each of the forms 901 through 903 can be used as an independent single form. However, by merging the forms 901 through 903, a new form can be generated. A method for generating a new form by merging a plurality of forms (the forms 901 through 903) is hereinafter referred to as a “merging form generation (method)” or a “plural form output (method)”. Furthermore, each of the merging target forms 901 through 903 is referred to as a “part format”.

In the present exemplary embodiment, the forms 901 through 903 have the following format names. That is, the format name of the form 901 is “part format (1)”, the format name of the form 902 is “part format (2)”, and the format name of the form 903 is “part format (3)”. The part formats (1) through (3) have file names “a01.form”, “a02.form”, and “a03.form”, respectively, which are enclosed within parentheses in FIG. 9.

For example, by merging the three forms 901 through 903, “formats (1)+(2)+(3)” 904, which is illustrated in FIG. 9B, can be generated. Similarly, by merging the forms 901 and 903, “formats (1)+(3)” 905 can be generated. Furthermore, by merging the forms 901 and 902, “formats (1)+(2)” 906 can be generated.

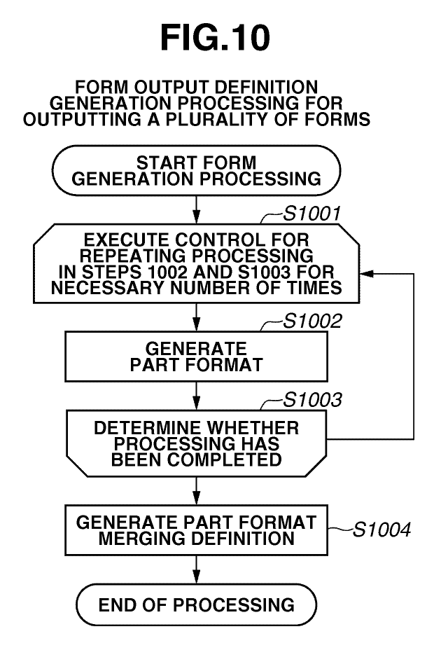

FIG. 10 is a flow chart illustrating exemplary form output definition generation processing according to an exemplary embodiment of the present invention. The processing illustrated in FIG. 10 is executed in outputting a plurality of forms. The processing illustrated in FIG. 10 corresponds to the form output definition generation processing illustrated in FIG. 7. Note that the processing according to the flow chart in FIG. 10 is implemented with the CPU 202 of the web application server 109 by reading and executing the content management application program on the PMEM 203 from the HDD 210. That is, each step in the flow chart in FIG. 10 is executed with the CPU 202 of the web application server 109 according to a command received from the content management application program stored on the PMEM 203. Hereinbelow, it is supposed that the content management application simply executes the processing for easier understanding.

In steps S1001 through S1003, the content management application executes control for repeating the processing in step S1002 for the number of necessary times (the number of times equivalent to the number of part formats to be visualized in outputting the form).

In step S1002, the content management application registers the part format on the content management application. The method for registering the part format on the content management application is similar to that illustrated in the flow chart in FIG. 7 (steps S701 through S707) except that in the processing illustrated in FIG. 10, it is not necessary to execute the login processing in step S701 every time the user logs into the application and the session can be kept alive once the user logs into the application. The processing in steps S702 through S707 is the same as that in FIG. 7. Therefore, the detailed description thereof will not be repeated.

After repeatedly executing the processing in steps S1001 through S1003, if it is determined in step S1003 that all the part formats to be visualized and output have been completely registered, then the content management application advances to step S1004.

In step S1004, the content management application receives a user designation of the combination of the part formats to be merged. Here, the user instructs the combination definition via the web browser of the client PC. Furthermore, the combination definition is a designation for merging the part formats of forms 901 and 902 (FIG. 9A) to generate and use the “formats (1)+(2)” 906 as the form to be output (a combined form having the form ID “form A”).

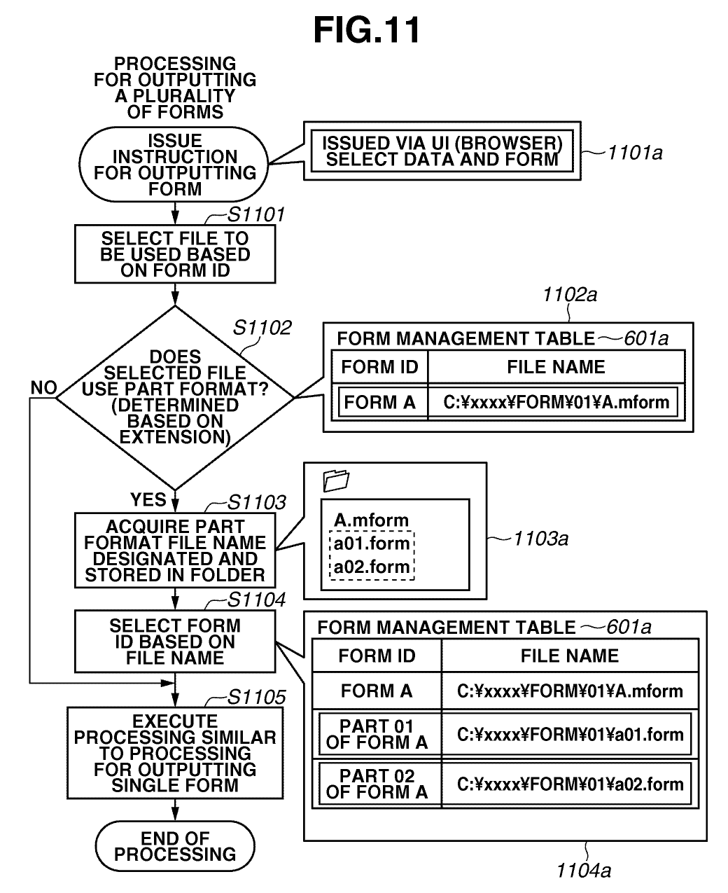

Note that in step S1002, the part format and the form to be output are registered by the same processing as that illustrated in FIG. 7. Therefore, in executing the processing in FIG. 10, the same structure of the folder storing the form as that of the folder in executing the processing illustrated in FIG. 7 is used. However, the part formats visualized and output on the form to be output are stored in the same folder (see processing 1103a in FIG. 11). Furthermore, one form to be output that is generated by merging the part formats is stored in one folder. However, the above-described configuration is a mere example and the present invention is not limited to this.

Hereinbelow, as illustrated in FIG. 9A, the extension of the file of the part format is “.form” and the extension of the form to be output generated by merging the part formats is “.mform” as illustrated in FIG. 9B.

FIG. 11 is a flow chart illustrating exemplary processing for outputting a plurality of forms according to an exemplary embodiment of the present invention. In the processing illustrated in FIG. 11, a form generated by merging the part formats is output. Accordingly, the processing illustrated in FIG. 11 is hereinafter referred to as “plural-form output processing”. Note that the processing according to the flow chart in FIG. 11 is implemented with the CPU 202 of the web application server 109 by reading and executing the content management application program on the PMEM 203 from the HDD 210. That is, each step in the flow chart in FIG. 11 is executed with the CPU 202 of the web application server 109 according to a command received from the content management application program stored on the PMEM 203. Hereinbelow, it is supposed that the content management application simply executes the processing for easier understanding.

A user instruction for outputting a plurality of forms is received via the web browser of the client PC.

After receiving an instruction for outputting a plurality of forms (including the form IDs thereof) via the web browser of the client PC 101 through 103, the content management application starts the processing in the flow chart in FIG. 11.

Referring to FIG. 11, in step S1101, the content management application refers to the form management table and selects the file to be used according to the form ID included in the instruction for outputting a plurality of forms.

In step S1102, the content management application determines whether the selected file uses the part format (whether the form is a combination form). Note that the determination is executed according to the file extension of the file selected in step S1101.

In the present exemplary embodiment, if the file uses the part format (if the form is a combination form) (YES in step S1102), then the file extension is “.mform”. Alternatively, if the file does not use the part format (if the form is not a combination form) (NO in step S1102), then the file extension is “.form”.

Note that in the example illustrated in processing 1102a, the content management application refers to the form management table 601a and determines the file name (the directory path) “C:¥xxx¥FORM¥01¥A.mform” according to the form ID “form A”. Thus, the combination form “A.mform” is selected.

If it is determined in step S1102 that the file selected in step S1101 does not use the part format (if the form is not a combination form, i.e., if the file extension is “.form”) (NO in step S1102), then the processing advances to step S1105.

When advancing from step S1102 to step S1105, the content management application executes the same processing as that in the processing for outputting a single form in steps S802 through S804 (FIG. 8A) on the file selected in step S1101. Then, the processing ends.

Alternatively, if it is determined in step S1102 that the file selected in step S1101 uses the part format (if the form is a combination form, i.e., if the file extension is “.mform”) (YES in step S1102), then the processing advances to step S1103.

In step S1103, the content management application refers to the acquired file path and acquires the file name of the part format existing within the folder. A folder 1103a in FIG. 11 has an exemplary configuration of the folder that uses the part format. In the exemplary processing illustrated in FIG. 11, in step S1103, the content management application acquires the file names “a01.form” and “a02.form” as the file names of the part formats.

In step S1104, the content management application refers to the form management table 601a and acquires the corresponding form ID according to the file name (the directory path) of the part format.

In processing 1104a illustrated in FIG. 11, the content management application acquires the form IDs (“part 01 of form A” and “part 02 of form A”) from the part format file names (“C:¥xxx¥FORM¥01¥a01.form” and “C:¥xxx¥FORM¥01¥a02.form”) acquired in step S1103.

In step S1105, the content management application outputs the form. Note that when advancing from step S1104 to step S1105, the content management application executes the same processing as that in the processing for outputting a single form in steps S801 through S804 (FIG. 8A) with respect to each form ID selected in step S1104.

More specifically, similar to the processing in step S801 (FIG. 8A), the content management application refers to the form management table 601a and selects the file to be used according to each form ID selected in step S1104. Then, similar to the processing in step S802 (FIG. 8A), the content management application refers to the form output definition management table 601b and acquires the data item key corresponding to each form file selected in step S801 (FIG. 8A). Then, similar to the processing in step S803 (FIG. 8A), the content management application transmits each file selected in step S801 (FIG. 8A) and each data corresponding to each data item key acquired in step S802 (FIG. 8A) to the form application. In the above-described manner, the combination form can be generated. Then, similar to the processing in step S804 (FIG. 8A), the content management application receives the electronic file (a PDF file, for example) corresponding to the combination form generated by the form application. Then, the content management application transmits the electronic file received from the form application in step S804 (FIG. 8A) to the client PC to display the content of the transmitted electronic file on the web browser of the client PC.

In the above-described manner, the content management application can execute the plural-form output processing, which is a method that is the premise to the present invention.

Now, processing for registering and managing a form that includes and processes a data area, which is useful and characteristic to the present invention, will be described in detail below.

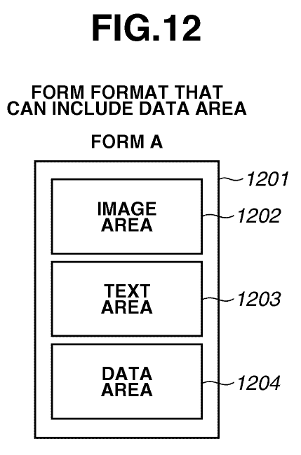

FIG. 12 illustrates an example of the form including the data area according to an exemplary embodiment of the present invention.

Referring to FIG. 12, the form 1201 includes an image area 1202, a text area 1203, and a data area 1204.

Meanwhile, the single form 503 (FIG. 5) and the combination forms 904 through 906 (FIG. 9B) each process an image area and a text area. In outputting the form like this, the content management application transmits an image and a character string to be embedded in the form to the form application.

In addition, in the present exemplary embodiment, the form 1201 (FIG. 12) is a form whose data area can be output. Here, similarly to the image area and the text area, the “data area” refers to an area of a form in which data is embedded. The data area can be output by designating the data to be embedded in the form to the form application.

Various methods for outputting the data area, such as a two-dimensional bar code, can be used. In the present exemplary embodiment, binary data is generated by encoding original data, the binary matrix is converted into dot patterns, and an image file having the dot-pattern image is processed. Note that the dot pattern generated in the above-described manner has a specific matrix pattern. The dot pattern image may seem to have dots randomly arranged. That is, the dot pattern cannot be interpreted even if it is closely studied with the eyes.

That is, as the method for outputting the data area, the present exemplary embodiment transmits a dot pattern image of the data area to the form application.

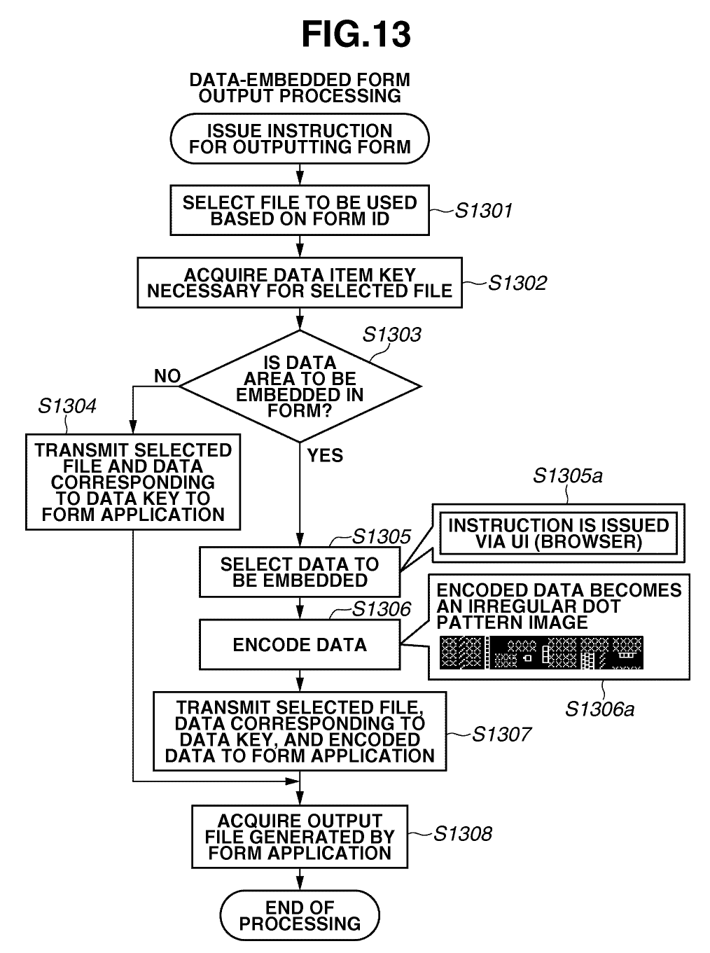

FIG. 13 is a flow chart illustrating exemplary processing for outputting a form including a data area according to an exemplary embodiment of the present invention. In the processing illustrated in FIG. 13, a form including a data area embedded therein is output. Accordingly, the processing illustrated in FIG. 13 is hereafter referred to as “data-embedded form output processing”. Note here that similar to the processing illustrated in FIG. 8A, the processing illustrated in FIG. 13 is a function of the content management application included in the received data registration function of the module 303 (FIG. 3).

Note that the processing executed according to the flow chart in FIG. 13 is implemented with the CPU 202 of the web application server 109 by loading and executing the content management application program on the PMEM 203 from the HDD 210. That is, each step in the flow chart in FIG. 13 is executed with the CPU 202 of the web application server 109 according to a command received from the content management application program stored on the PMEM 203. Hereinbelow, it is supposed that the content management application simply executes the processing for easier understanding.

A user instruction for outputting a data-embedded form is received via the web browser of the client PC.

After receiving a user instruction (including the form ID) for outputting a data-embedded form via the web browser of the client PC, the content management application starts the processing in the flow chart in FIG. 13.

Referring to FIG. 13, in step S1301, the content management application refers to the form management table 601a and selects the file to be used according to the form ID designated in the instruction for outputting the form.

In step S1302, the content management application refers to the form output definition management table 601b and acquires a data item key corresponding to the form file selected in step S801.

In step S1303, the content management application determines whether to embed the data in the designated form (whether the designated form is a data-embedded form). In this regard, it is also useful if the determination in step S1303 is executed according to whether any data area has been defined in the designated form. Furthermore, it is also useful if the determination in step S1303 is executed based on a designation by the user performed via the web browser of the client PC. In this case, the determination as to whether any data area has been defined in the designated form can be executed according to whether the type of the item of the data item key acquired in step S1302 is “embed data”.

If it is determined in step S1303 that data is not to be embedded in the designated form (NO in step S1303), then the processing advances to step S1304.

In step S1304, the content management application transmits the file selected in step S1301 and the data corresponding to the data item key acquired in step S1302 to the form application. Then, the processing advances to step S1308.

Alternatively, if it is determined that data is to be embedded in the designated form (YES in step S1303), then the processing advances to step S1305.

In step S1305, the content management application displays the UI (the UI for selecting the data to be embedded) on the web browser of the client PC to allow the user to select the data to be embedded via the web browser.

In step S1306, the content management application encodes the data selected in step S1305 (the data to be embedded) By the encoding processing instep S1306, the data to be embedded is converted into a dot pattern image in step S1306a.

Here, the data encoding processing can be executed by using one of the functions of the content management application or by using an external library. Furthermore, the content management application is an interface for acquiring the encoded dot pattern image. In addition, with respect to the method for encoding the data, various methods can be used. That is, any appropriate method such as the dot pattern image in step S1306a or high density bar codes such as two-dimensional bar codes can be used.

In step S1307, the content management application transmits the encoded data generated in step S1306, the file selected in step S1301, and the data corresponding to the data item key acquired in step S1302 to the form application. Then, the processing advances to step S1308. In the above-described manner, the form application can generate a data-embedded form.

In step S1308, the content management application receives the form data (PDF data, for example) output by the form application. Then, the processing in FIG. 13 ends. In the above-described manner, the present exemplary embodiment can output a data-embedded form.

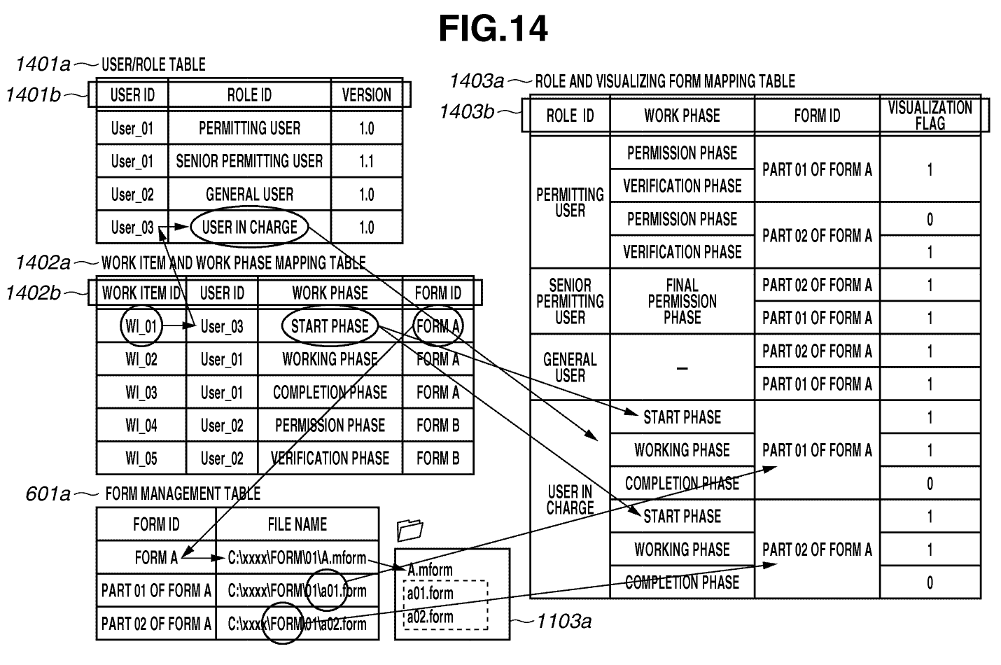

FIG. 14 illustrates a database schema including a role, a work item, and a visualizing format according to an exemplary embodiment of the present invention. The database is used by the content management application and is provided within the database 110.

Note that the “role” indicates a business role or a job title of a user. The content management application includes a work flow function. The item “role” is necessary and used in executing the work flow. The content management application manages the role in association with user information.

Referring to FIG. 14, a user/role table 1401a manages the user information and the role used by the content management application. When a user is registered, the user management function of the module 303 issues a unique user ID of the registered user and assigns the role thereto by using a table definition 1401b. The role to be assigned can be designated when the user is registered. That is, the user/role table 1401a stores user-role correspondence information that defines role information corresponding to each user information (a user ID).

Furthermore, the table definition 1401b can include version information. With this configuration, the table definition 1401b can manage a plurality of combinations of the user and the corresponding role. In this case, it is supposed that the role of the user may change according to a time frame.

A mapping table 1402a stores the work item and a work phase. When a work flow control function of the content management application is executed and the user has started the work flow, the content management application issues a work item. A work item refers to an item for executing processing according to a predetermined work flow. A flow “apply→verify→approve”, for example, can be used as the work flow.

Furthermore, the timing for issuing a work item is determined according to a definition included in the work flow. In this regard, for example, a work item can be issued when the user logs into the system or when the user instructs the start of the work flow via the UI. Furthermore, a work item can be automatically issued when a form is scanned.

When a work item is issued, the content management application issues a unique work item ID and assigns a user who executes the processing by using the table definition 1402b.

The work item includes a work phase. The work phase is stored in and managed by the work item and work phase mapping table 1402a.

Furthermore, in the present exemplary embodiment, a work flow uses a form. The work item and work phase mapping table 1402a manages the work item and the form ID associated with each other. That is, the content management application can refer to the work item and work phase mapping table 1402a to acquire a user ID of a user who processes the work item, the work phase of the work item, and information about the form to be used.

More specifically, the work item and work phase mapping table 1402a stores information defining the correspondence among the work flow information (work item ID), the role information (the role ID), and the work phase of the work flow. Note that the work phase is managed by the work flow control function of the module 303 (FIG. 3) of the web application server 109.

A mapping table 1403a stores the role and a visualizing format. In this regard, as described above with reference to FIGS. 9A and 9B, a combination form can be generated by merging a plurality of part formats into one form. In the present exemplary embodiment, a form to be output can be changed by utilizing the method for generating a combination form. More specifically, the role and visualizing format mapping table 1403a stores role-visualizing format correspondence information, which defines the part format (form ID) to be visualized and output within the form format with respect to each combination of the role information (role ID) and the work phase of the work flow.

In this regard, for example, if the part formats 901 through 903 are provided, the “formats (1)+(2)+(3)” 904 is output with respect to a role and the “formats (1)+(3)” 905 is output with respect to another role by using the role and visualizing format mapping table 1403a.

A table definition 1403b of the role and visualizing format mapping table 1403a includes items such as a role ID, a work phase, a form ID, and a visualization flag. In the present exemplary embodiment, the form to be output is changed according not only to the role but also to the work phase. In changing the form, the content management application executes control for outputting a form whose part format for which the visualization flag is enabled is displayed and whose part format for which the visualization flag is disabled is not displayed.

Now, the control executed by the content management application in the following exemplary case will be described in detail below. Suppose that processing of a work item ID “WI_01” (stored in the work item and work phase mapping table 1402a) has been started. In this case, it can be known from the work item and work phase mapping table 1402a that the user who can execute the work item ID “WI_01” is a user having the user ID “User_03”.

Furthermore, by referring to the user/role table 1401a, it is known that the role of the user having the user ID “User_03” is the “user in charge”. In addition, by referring to the work item and work phase mapping table 1402a, it is known that the work phase of the work item ID “WI_01” is “start phase” and that the form to be used is a form having the form ID “form A”. By referring to the form management table 601a (FIG. 6), the form file name can be acquired according to the form ID, as described above with reference to FIG. 6.

The corresponding form file name “A.mform” indicates that the form is a combination form. Accordingly, it is known that two part formats “a01.form” and “a02.form”, which are stored in the form file storage folder 1103a, are used. In addition, by referring to the form management table 601a, it is known that the form IDs of the part formats “a01.form” and “a02.form” are “part 01 of form A” and “part 02 of form A”, respectively.

By applying the above-described information to the role and visualizing format mapping table 1403a, a value “1” (“enabled”) has been set for the visualization flag of “part 01 of form A” corresponding to “user in charge” and “start phase”. Similarly, a value “1” (“enabled”) has been set for the visualization flag of “part 02 of form A” corresponding to “user in charge” and “start phase”.

Note that the database 110 stores information in the user/role table 1401a, the work item and work phase mapping table 1402a, the role and visualizing format mapping table 1403a, and the form management table 601a. Furthermore, the role and visualizing format mapping table 1403a is stored with respect to each form format (a combined form format part including a plurality of part formats).

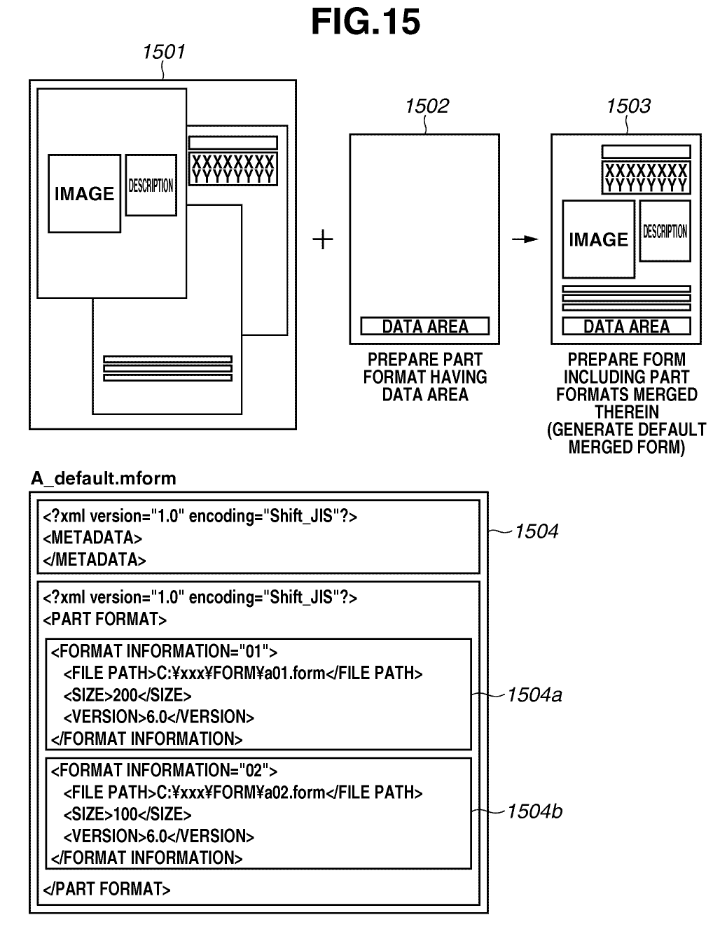

FIG. 15 illustrates an example of a form that includes and processes a data area and a part format according to an exemplary embodiment of the present invention.

In the present exemplary embodiment, a combination form that includes a plurality of part formats is used. Furthermore, a data area is embedded in a form as described above with reference to FIGS. 12 and 13. Accordingly, in the present exemplary embodiment, it is necessary to prepare a form having both of these characteristics.

Referring to FIG. 15, the present exemplary embodiment generates a combination form 1503, which is generated by merging part formats 1501 and 1502. The part format 1501 includes an image area and a text area. The part format 1502 includes a data area. The data area of the part format 1502 is similar to the data area 1204 in FIG. 12. Hereinbelow, the combination form 1503 is also referred to as a “default combination form” 1503.

A data structure 1504 is an example of a structure of data of the default combination form 1503. In the present exemplary embodiment, the default combination form 1503 is generated based on a markup text such as eXtended Markup Language (XML). However, the present invention is not limited to this. In the example illustrated in FIG. 15, the default combination form 1503 includes descriptions designating the part formats to be visualized and output only for easier understanding. However, in actual processing, the default combination form 1503 can include more information described as the data structure 1504.

Furthermore, the data structure 1504 includes descriptions 1504a and 1504b of a part format to be visualized and output. As described above, the default combination form 1503 includes information about the part format to be visualized and output. Note that the form application interprets the part format information 1504a and 1504b and generates an output form.

Tags “<SIZE>” and “<VERSION>” included in the information 1504a and 1504b can be expanded. Furthermore, the description 1504 is a mere example of a default combination form. That is, it is not always necessary to provide a “<SIZE>” tag in a default combination form format. Accordingly, the data structure 1504 can include any information with which a part format to be visualized and output can be identified.

In addition, the default combination form 1503 includes a description of a part format to be visualized and output. All part formats corresponding to the information 1504a and 1504b of the description 1504 are visualized. Furthermore, the default combination form 1503 is a kind of a combination form. Accordingly, in the present exemplary embodiment, the default combination form 1503 has an extension “.mform”.

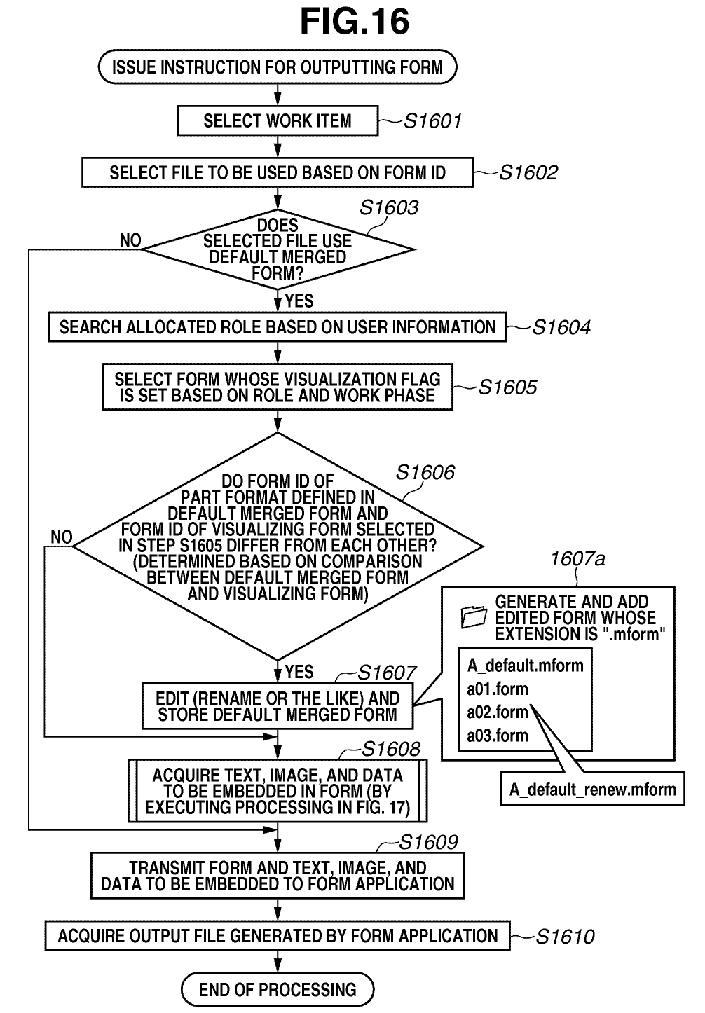

Now, a method for outputting a form embedded with a logic for changing a condition for visualizing a form according to role information will be described in detail below with reference to FIG. 16.

FIG. 16 is a flow chart illustrating exemplary processing for changing a form to be output according to a role according to an exemplary embodiment of the present invention.

Note that the processing executed according to the flow chart in FIG. 16 is implemented with the CPU 202 of the web application server 109 by loading and executing the content management application program on the PMEM 203 from the HDD 210. That is, each step in the flow chart in FIG. 16 is executed with the CPU 202 of the web application server 109 according to a command received from the content management application program stored on the PMEM 203. Hereinbelow, it is supposed that the content management application simply executes the processing for easier understanding.

When a user who has logged into the web application server 109 has issued a form outputting instruction via the web browser of the client PC, the content management application starts the processing in the flow chart in FIG. 16.

Referring to FIG. 16, in step S1601, the content management application receives a selection of a work item by the user via the web browser of the client PC.

In step S1602, the content management application selects the form file to be used according to the form ID. More specifically, the content management application refers to the mapping table 1402a according to the work item and acquires the user ID of the user who processes the work item selected in step S1601, the work phase of the work item, and information about the form to be used. Then, the content management application refers to the form management table 601a according to the received form ID and acquires the file name. Then, the content management application refers to the form file storage folder 1103a corresponding to the received file name and selects the form file to be used.

In step S1603, the content management application determines whether the file selected in step S1602 is a file that uses a default combination form. Note that the content management application executes the determination in step S1602 according to the file name of the file selected in step S1603. In the present exemplary embodiment, if the selected file is a file that uses a default combination form, the latter half of the file name is “_default.mform”. Alternatively, if the selected file is not a file that uses a default combination form, the latter half of the file name is not “_default.mform”.

If the file selected in step S1602 is not a file that uses a default combination form (NO in step S1603), then the content management application advances to step S1609. Alternatively, if the file selected in step S1602 is a file that uses a default combination form (YES in step S1603), then the content management application advances to step S1604.

In step S1604, the content management application searches for an assigned role ID according to the user information. More specifically, by referring to the user/role table 1401a according to the user ID of the user who processes the work item acquired in step S1602, the content management application acquires the role ID corresponding to the user who processes the work item.

In step S1605, the content management application refers to the role and visualizing format mapping table 1403a according to the role ID acquired in step S1602, the work phase, and the form ID and selects a form whose form ID has been designated to be visualized. The method for searching for the form is as described above with reference to FIG. 14.

In step S1606, the content management application determines whether the form ID of the part format defined in the default combination form and the form ID of the form that has been identified in step S1605 as a form whose form ID has been designated to be visualized are different from each other.

If it is determined that the form IDs differ from each other (YES in step S1606), then the content management application advances to step S1607. Alternatively, if it is determined that the form IDs do not differ from each other (NO in step S1606), then the content management application advances to step S1608.

In step S1607, the content management application executes an editing operation on the default combination format. In the editing operation, the content management application adds a part format to be visualized, such as the information 1504a and 1504b (FIG. 15). Furthermore, if a part format is included in the default combination form but the part format included in the default combination form is not included in the form selected in step S1605, the content management application deletes the description corresponding to the part format from the default combination form.

After editing the default combination form in the above-described manner, the content management application stores the form that includes the description of the part format to be visualized in the default combination form only. Note here that the content management application can temporarily store the form on a memory. Alternatively, the content management application can copy and rename the default combination format 1504 and store the renamed default combination form as a different default combination format.

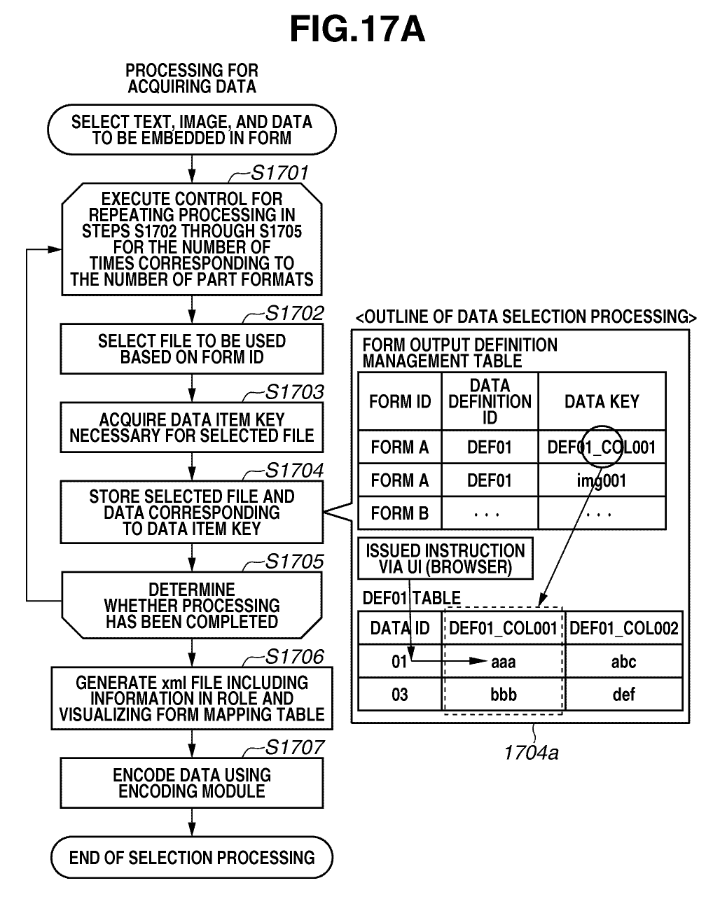

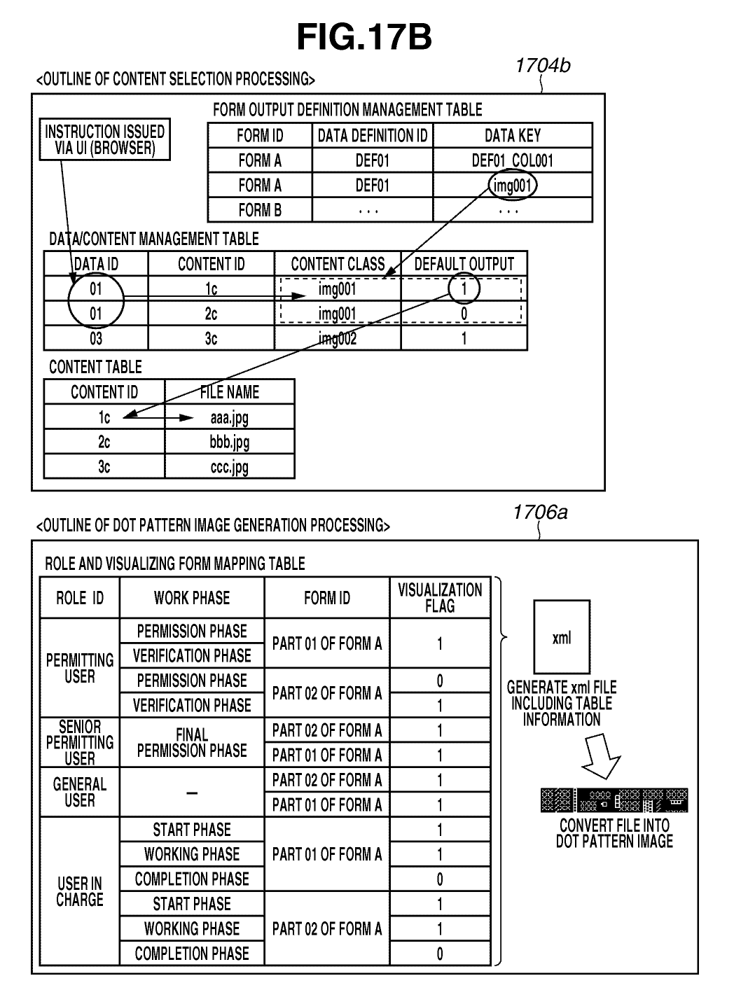

In step S1608, the content management application acquires the image, the text, and the data to be embedded in the form. The processing in step S1608 will be described in detail later below with reference to FIG. 17.

In step S1609, the content management application transfers the form to be used and the data to be used (the image, the text, and the data to be embedded in the form, which have been acquired in step S1608) to the form application to cause the form application to generate a form. Note that the form to be used includes the edited default combination form and the part format. In this regard, if it is determined in step S1603 that the file selected in step S1602 is not a default combination form, the form to be used includes the part format of the form selected in step S1602. Furthermore, if it is determined that the form IDs are not different from each other, the form to be used includes an unedited default combination form and the part format associated therewith.

In step S1610, the content management application receives an output product (an electronic file) generated by the form application. Then, the processing ends.

FIG. 17A is a flow chart illustrating an example of processing in step S1608 in FIG. 16 for acquiring an image, a text, and data, which are to be embedded in a form, according to an exemplary embodiment of the present invention. That is, FIG. 17A illustrates an example of a method for selecting, acquiring, and generating the data to be transmitted to the form application.

Note that the processing executed according to the flow chart in FIG. 17A is implemented with the CPU 202 of the web application server 109 by loading and executing the content management application program on the PMEM 203 from the HDD 210. That is, each step in the flow chart in FIG. 17A is executed with the CPU 202 of the web application server 109 according to a command received from the content management application program stored on the PMEM 203. Hereinbelow, it is supposed that the content management application simply executes the processing for easier understanding.

FIG. 17B illustrates an example of processing in step S1608 in FIG. 16 for acquiring an image, a text, and data, which are to be embedded in a form, according to an exemplary embodiment of the present invention.

Referring to FIG. 17A, in steps S1701 through S1705, the content management application performs control for repeatedly executing processing in steps S1702 through S1704 for the number of times equivalent to the number of part formats.

In step S1702, the content management application refers to the form management table 601a according to the form ID and selects the file to be used in the manner similar to the processing described above in step S801 (FIG. 8).

In step S1703, the content management application acquires the data item key corresponding to the form file selected in step S1702 in the manner similar to the processing described above in step S802 (FIG. 8).

In step S1704, the content management application acquires the file selected in step S1702 and the data corresponding to the data item key selected in step S1703 and stores the acquired file and data on the memory. Note that a data selection outline 1704a (FIG. 17A) and a content selection outline 1704b (FIG. 17B) each illustrate the outline of processing in steps S1703 and step S1704. Note that the data selection outline 1704a is similar to a content selection outline 303a (FIG. 8) and that the content selection outline 1704b is similar to a data selection outline 303b (FIG. 8). Accordingly, the description thereof will not be repeated here.

When the loop processing in steps S1701 through S1705 ends, the content management application advances to step S1706. By performing the above-described processing in steps S1701 through S1705, the text and the image to be embedded in the form is stored on the memory.

In step S1706, the content management application converts the role and visualizing format mapping table 1403a into XML data.

In step S1707, the content management application encodes the role and visualizing format mapping table 1403a converted into XML data in step S1706 and generates a dot pattern image. The processing in step S1707 is executed in the manner similar to the processing in step S1307 in FIG. 13. The data embedded in step S1707 is the visualizing format mapping table. The information included in the table is converted into XML data. This is because the data can be more easily processed in a file rather than being stored on the memory. Note here that the table can be converted into a data format other than XML. A dot pattern image generation processing outline 1706a illustrates the outline of the processing in steps S1705 and S1706.

When the processing in step S1707 ends, the content management application ends the processing in FIG. 17A. The file including the text and the image and the dot pattern image generated in the above-described manner are used in step S1609 (FIG. 16).

By executing the above-described processing, the present exemplary embodiment can generate a form whose visualizing area has been changed according to the role of the user by using the content management application.

Now, processing executed when the user uses the form will be described in detail later below.

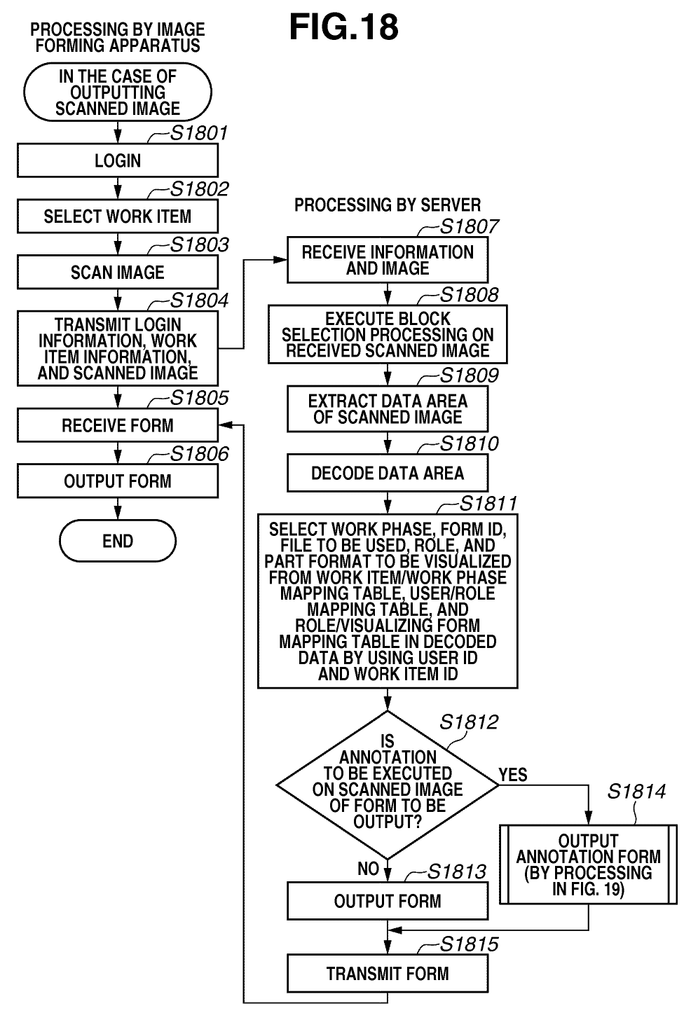

FIG. 18 is a flow chart illustrating an example of processing for using, from the image processing apparatus, a form (a form whose visualizing area has been changed according to a role) that has been output by the form output processing (FIG. 16) according to the present exemplary embodiment.

The processing in the flow chart in FIG. 18 is executed on the image processing apparatuses 111 and 112 and the web application server 109, which executes the content management application. Note that processing in steps S1801 through S1806 corresponds to each step executed by the image processing apparatuses 111 and 112. Furthermore, processing in steps S1807 through S1815 corresponds to each step executed by the web application server 109.

The processing in step S1801 through S1806 is executed with the calculation processing unit 310 of the image processing apparatuses 111 and 112 by reading and executing the program from the program storage unit 312. That is, each of steps S1801 through S1806 is executed with the calculation processing unit 310 of the image processing apparatuses 111 and 112 according to a command from the program stored on the program storage unit 312. Hereinbelow, it is supposed that the calculation processing unit 310 simply executes the processing for easier understanding.

Furthermore, the processing in steps S1807 through S1815 is implemented with the CPU 202 of the web application server 109 by reading and executing the content management application program on the PMEM 203 from the HDD 210. That is, each step in the flow chart in FIG. 18 is executed with the CPU 202 of the web application server 109 according to a command received from the content management application program stored on the PMEM 203. Hereinbelow, it is supposed that the content management application simply executes the processing for easier understanding.

Referring to FIG. 18, when the calculation processing unit 310 detects a login operation by the user on the input unit 308 of the image processing apparatuses 111 and 112, the calculation processing unit 310 executes user login processing.

In step S1802, the calculation processing unit 310 of the image processing apparatuses 111 and 112 receives the user selection of the work item to be processed from the input unit 308 of the image processing apparatuses 111 and 112.

In step S1803, when the user sets a form on the scanner unit 313, the calculation processing unit 310 of the image processing apparatuses 111 and 112 scans the set form with the scanner unit 313. Note that the form scanned in step S1803 is the form whose visualizing area can be changed, which has been output by the form output processing illustrated in FIG. 16.

In step S1804, the calculation processing unit 310 of the image processing apparatuses 111 and 112 transmits login information, work item information, and the scanned data to the content management application operating on the web application server 109 (transmission processing). Note that the login information to be transmitted is the user login information (user ID or the like) used in the login processing in step S1801. Furthermore, the work item information to be transmitted here is the work item information (work item ID or the like) corresponding to the work item selected in step S1802. Moreover, the scanned data transmitted here is the scanned data read in step S1803.

In step S1807, the content management application receives the information transmitted from the image processing apparatuses 111 and 112 in step S1804 (the login information, the work item information, and the scanned data).

In step S1808, the content management application executes block selection processing on the scanned data received in step S1807. In step S1809, the content management application extracts the dot pattern image area of the image as a data area.

In step S1810, the content management application decodes the data area extracted in step S1808 and extracts original data. Note that the data decoding processing can be executed by using one of the functions of the content management application or by using an external library, similar to the operation by the module that executes encoding in step S1306 (FIG. 13). If an external library is used, the content management application includes an interface for acquiring the original data decoded from the dot pattern image.

In step S1811, the content management application refers to the work item and work phase mapping table 1402a according to the user ID and the work item ID received in step S1807 and selects the work phase and the form ID according to the work item ID. In addition, the content management application refers to the form management table 601a according to the selected form ID and acquires the format file name.

Furthermore, the content management application refers to the user/role table 1401a and selects the role ID corresponding to the user ID received in step S1807. Furthermore, the content management application refers to the role and visualizing format mapping table 1403a decoded in step S1810 according to the selected role and the acquired work phase. Moreover, the content management application selects the form ID of the form whose form ID has been designated to be visualized and designates the selected form ID as the part formats of the form to be output.

In step S1812, the content management application determines whether to output the form whose scanned image has been subjected to annotation processing. Information about whether to execute annotation can be included in the form by using a tag provided in a form file acquired in step S1811 (i.e., the default combination form 1504 (FIG. 15)). Note that it is also useful if the information about whether to execute annotation is instructed by the user via the input unit 308 of the image processing apparatuses 111 and 112 at a timing of executing the processing in step S1804 instead of providing the form with the annotation execution designating information.

If it is determined that annotation is not to be executed (NO in step S1812), then the processing advances to step S1813 (form output processing). The form output processing is similar to the processing illustrated in FIG. 16 except that the selection of the work item and the form file in steps S1601 and S1602, which has already been executed in this case, is not necessary.

Alternatively, if it is determined to execute annotation (YES in step S1812), then the processing advances to step S1814.

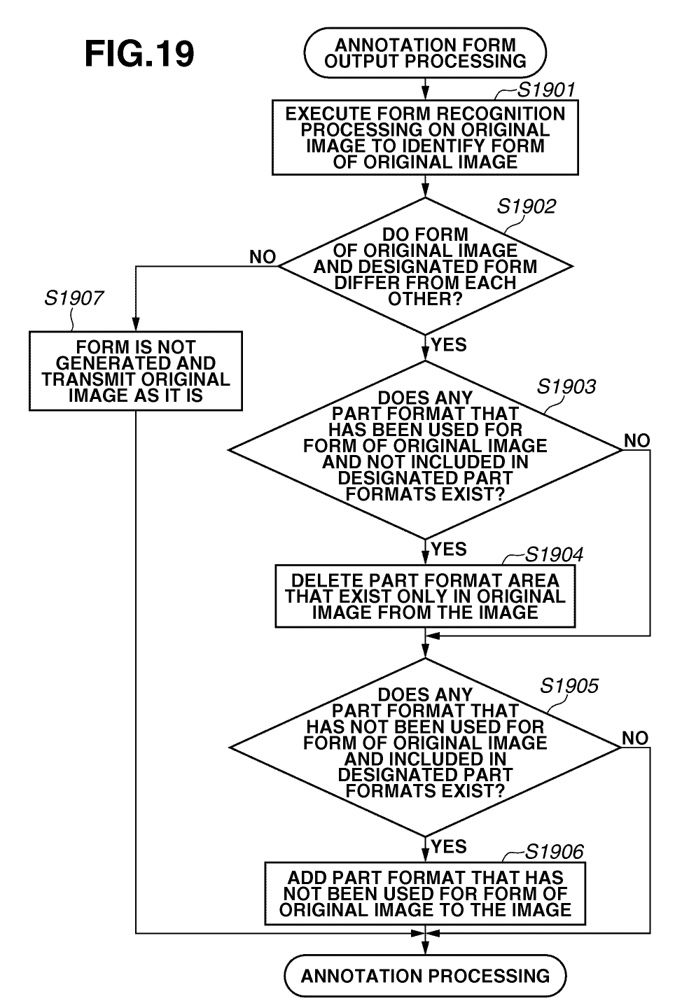

In step S1814, the content management application outputs an annotation form. The annotation processing in step S1814 will be described in detail later below with reference to FIG. 19.

After acquiring the form output by step S1814, the content management application advances to step S1815. Instep S1815, the content management application transmits the form to be output, which has been acquired in step S1813 or S1814, to the image processing apparatuses 111 and 112.

In step S1805, the calculation processing unit 310 of the image processing apparatuses 111 and 112 receives the file (form) transmitted in step S1804 from a content management server of the web application server 109. In step S1806, the calculation processing unit 310 of the image processing apparatuses 111 and 112 prints the form received in step S1805 with the printer unit 314. Then, the processing in FIG. 18 ends.

By executing the above-described processing, the present exemplary embodiment can output the form scanned by the user as the form whose visualizing area has been changed according to the role of the user and the work phase.

FIG. 19 is a flow chart illustrating exemplary annotation form output processing in step S1814 in FIG. 18 according to the present exemplary embodiment.

Note that the processing executed according to the flow chart in FIG. 19 is implemented with the CPU 202 of the web application server 109 by loading and executing the content management application program on the PMEM 203 from the HDD 210. That is, each step in the flow chart in FIG. 19 is executed with the CPU 202 of the web application server 109 according to a command received from the content management application program stored on the PMEM 203. Hereinbelow, it is supposed that the content management application simply executes the processing for easier understanding.

Referring to FIG. 19, in step S1901, the content management application recognize the original image (the scanned image received from the image processing apparatuses 111 and 112 in step S1807) as a form and determines to which of the forms managed in the form management table 601a the form corresponds. Note that the form is a combination form. Accordingly, the content management application identifies and recognizes all the part formats used in the form.

In step S1902, the content management application determines whether the format of the original image identified and recognized in step S1901 (the part formats) and the format designated in step S1811 according to the user role and the work phase (the part formats that have been designated to be visualized) differ from one another.

If it is determined that the formats do not differ from one another (if the part format obtained by scanning on the image processing apparatuses 111 and 112 and the part format to be visualized corresponds to the user role are the same) (NO in step S1902), then the content management application advances to step S1907.

If the part formats do not differ from one another (NO in step S1902), then in step S1907, the content management application does not generate a new form and transmits the original image to the image processing apparatuses 111 and 112 as it is. Then, the content management application returns to the processing in the flow chart in FIG. 18. Alternatively, if it is determined that the part formats differ from one another (YES in step S1902), then the processing advances to step S1903.

In step S1903, the content management application determines whether any part format exists that is used in the original image but not included in the part format designated in step S1811. If it is determined in step S1903 that a part format exists that is used in the original image but not included in the part format designated in step S1811 (YES in step S1903), then the processing advances to step S1904. In this case, an area that is not to be visualized in the current work phase of the work item by the login user has been printed in the original image.

In step S1904, the content management application deletes the part format that has not been included in the part formats designated in step S1811 but included in the original image. Then, the processing advances to step S1905.

Alternatively, if no part format exists that is used in the original image and not included in the part formats designated in step S1811 (NO in step S1903), then the processing advances to step S1905.

In step S1905, the content management application determines whether any part format that is not included in the original image but used in the part formats designated in step S1811 exists.

If it is determined that a part format that is not included in the original image but used in the part formats designated in step S1811 exists (YES in step S1905), then the processing advances to step S1906. In step S1906, the content management application annotates the part format that has not been included in the original image and adds the part format to the original image. More specifically, the content management application adds the part format that has not been visualized in the original image to the original image. By executing the above-described processing, a form whose original image has been subjected to annotation processing can be output. When the processing in step S1906 ends, the content management application returns to the processing in the flow chart in FIG. 18.

As described above, the present exemplary embodiment changes a form to be output according to a combination of the user role and the work phase of the work flow executed by the user. Accordingly, the present exemplary embodiment can output the information necessary and desired by the user in the work phase only. Thus, the present exemplary embodiment can prevent the user from performing a complicated operation.

Similarly, in the case of outputting a form by scanning the form on the image processing apparatuses 111 and 112, the present exemplary embodiment can output a form by changing the form to be output according to the combination of the user role and the work phase. Accordingly, the present exemplary embodiment can generate a form a subsequent user fills in while preventing the leakage of private information of a previous user entered in the form obtained by scanning. That is, the present exemplary embodiment can “mask” the private information of a user that is not necessary to another user.

With the above-described configuration, the present exemplary embodiment can easily generate a form according to the work phase of a work flow executed based on one form (and the role of the user who processes the form).

In the above-described first exemplary embodiment, the role and visualizing format mapping table 1403a is first converted into XML data and then into a dot pattern image, and the dot pattern image is embedded in the data area of a form. Accordingly, in the first exemplary embodiment, it is necessary, in outputting a form from the image processing apparatuses 111 and 112 according to the user role, for the image processing apparatuses 111 and 112 to communicate with the web application server 109 and receive a new form to be output from the web application server 109.

In this regard, a second exemplary embodiment of the present invention changes the form to be output when the image processing apparatuses 111 and 112 cannot communicate with the web application server 109. Note here that components and units that are similar to those of the first exemplary embodiment are provided with the same reference numerals and symbols. Accordingly, the detailed description thereof will not be repeated here.

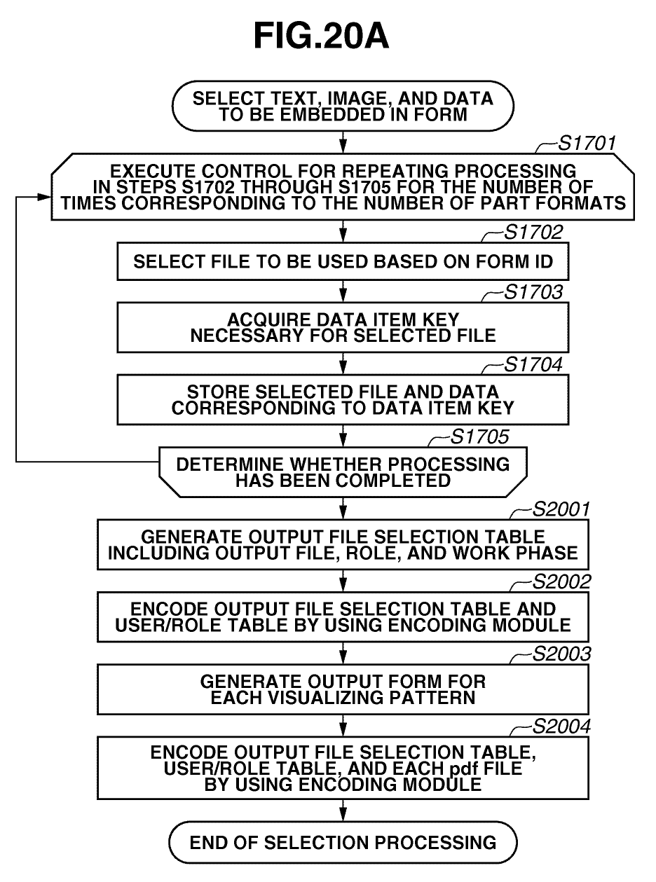

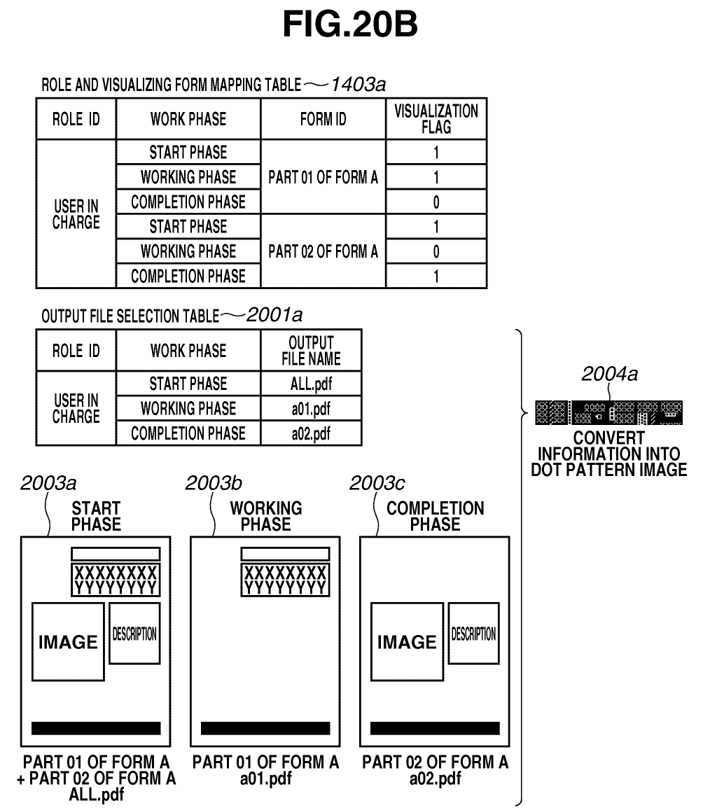

FIG. 20A is a flow chart illustrating an example of the processing in step S1608 in FIG. 16 for acquiring the image, the text, and the data, which are to be embedded in the form according to the present exemplary embodiment. The processing illustrated in FIG. 20A partly differs from the processing in the flow chart in FIG. 17A.

Note that the processing executed according to the flow chart in FIG. 20A is implemented with the CPU 202 of the web application server 109 by loading and executing the content management application program on the PMEM 203 from the HDD 210. That is, each step in the flow chart in FIG. 20A is executed with the CPU 202 of the web application server 109 according to a command received from the content management application program stored on the PMEM 203. Hereinbelow, it is supposed that the content management application simply executes the processing for easier understanding. Furthermore, steps similar to those in the flow chart in FIG. 17 are provided with the same step reference numerals. Accordingly, the detailed description thereof will not be repeated here.

FIG. 20B illustrates an example of processing in step S1608 in FIG. 16 for acquiring the image, the text, and the data, which are to be embedded in the form according to the second exemplary embodiment of the present invention.

When the loop processing in steps S1701 through S1705 ends, the content management application starts the processing in the flow chart in FIG. 20A. Referring to FIG. 20A, in step S2001, the content management application generates an output file selection table 2001a (FIG. 20B) with respect to each combination of the role and the work phase (or with respect to each visualization pattern).

The processing in step S2001 will be described in detail below. By referring to the role and visualizing format mapping table 1403a (FIG. 14), it is known that in outputting a form, specific form patterns may become necessary according to the state of the visualization flag with respect to the role ID and the work phase.

In this regard, in the case of the “user in charge” in the role and visualizing format mapping table 1403a, in the “start phase”, a form having the form IDs “part 01 of form A” and “part 02 of form A” is necessary. Similarly, a form whose form ID is “part 01 of form A” is necessary in the “working phase.” Furthermore, in the “completion phase”, the form whose form ID is “part 02 of form A” is necessary.

In this case, in step S2001, the content management application provides an output file name to the form with respect to each visualization pattern of the form. Furthermore, the content management application generates the output file selection table 2001a (FIG. 20B) storing the output file name linked with the role ID and the work phase with respect to each combination of the role ID and the work phase. By referring to the output file selection table 2001a, the content management application can identify the output file of the form to be used if the role and the work phase can be identified thereby even if the image processing apparatuses 111 and 112 do not communicate with the web application server 109.

More specifically, the output file selection table 2001a stores role-output data correspondence information. The role-output data correspondence information includes the output data of the generated form (output file name) corresponding to each combination of the role and the work phase. In the example illustrated in FIG. 20B, the information about the user whose role ID is “user in charge” only is illustrated as information stored in the output file selection table 2001a. In this regard, however, in step S2001, the content management application generates the output file selection table 2001a storing the output file name corresponding to each combination of each role (permitting user, senior permitting user, general user, or user in charge) and each work phase (start phase, working phase, or completion phase).

In step S2002, the content management application encodes the user/role table 1401a (FIG. 14) and the output file selection table 2001a generated in step S2001 to generate a dot pattern image. The dot pattern image is generated by the processing similar to that executed in step S1707 (FIG. 17).

In step S2003, the content management application generates an output file, which is set while being linked with the work phase in the output file selection table 2001a, with respect to each visualization pattern by using the form application (i.e., with respect to each combination of part formats). In this case, the content management application designates the form file to be used, the data stored in step S1704, and the dot pattern image generated in step S2002 on the form application with respect to each visualization pattern.

In the example illustrated in FIG. 20B, files 2003a, 2003b, and 2003c (“ALL.pdf”, “a01.pdf”, and “a02.pdf”) are generated. More specifically, in step S2003, the content management application executes control for generating all output files (form output data files) corresponding to the visualization pattern determined according to the combination of each role (permitting user, senior permitting user, general user, or user in charge) and each work phase (start phase, working phase, or completion phase). Instep S2004, the content management application encodes the user/role table 1401a, the output file selection table 2001a, and the generated files 2003a, 2003b, and 2003c and generates a dot pattern image thereof. Then, the content management application returns to the processing in the flow chart in FIG. 16. That is, the content management application transmits a dot pattern image 2004a generated in step S2004 and the like to the form application in step S1609 (FIG. 16).

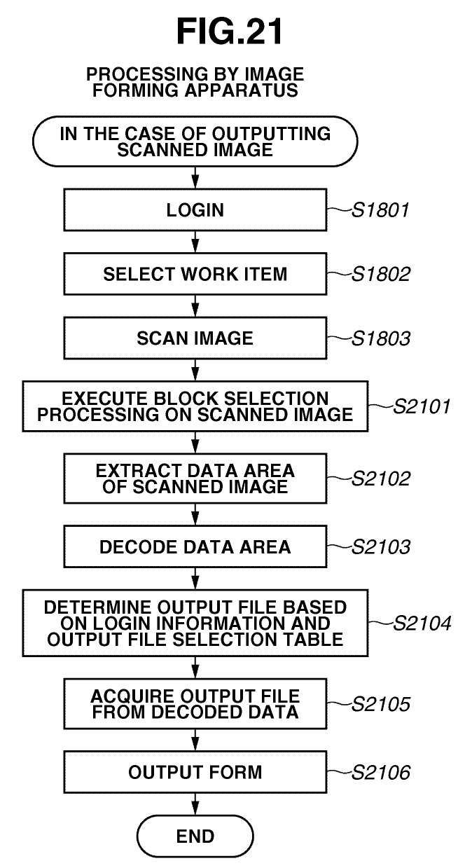

Now, processing executed when the user uses the form will be described in detail below. FIG. 21 is a flow chart illustrating an example of the processing for using, from an image processing apparatus, the form (a form whose visualizing area has been changed according to the role) that has been output by the form output processing (FIG. 20A) according to the present exemplary embodiment.

Note that the processing in the flow chart in FIG. 21 is executed with the calculation processing unit 310 of the image processing apparatuses 111 and 112 by reading and executing the program from the program storage unit 312. That is, each of steps S1801 through S1803 and each of steps S2101 through S2106 is executed with the calculation processing unit 310 of the image processing apparatuses 111 and 112 according to a command from the program stored on the program storage unit 312. Hereinbelow, it is supposed that the calculation processing unit 310 simply executes the processing for easier understanding. Furthermore, steps similar to those in the flow chart in FIG. 18 are provided with the same step reference numerals as those in the flow chart in FIG. 18. Accordingly, the detailed description thereof will not be repeated here.

When the processing in step S1803 ends, the calculation processing unit 310 of the image processing apparatuses 111 and 112 starts the processing in FIG. 21. Referring to FIG. 21, in step S2101, the calculation processing unit 310 of the image processing apparatuses 111 and 112 executes block selection processing on the image acquired by scanning in step S1803. In step S2102, the calculation processing unit 310 extracts a dot pattern image area of the scanned image as a data area.

In step S2103, the calculation processing unit 310 of the image processing apparatuses 111 and 112 decodes the data area extracted in step S2102 and extracts original data thereof.

In step S2104, the calculation processing unit 310 of the image processing apparatuses 111 and 112 determines an output file according to the output file selection table 2001a and the user/role table 1401a included in the information decoded in step S2103.

In step S2105, the calculation processing unit 310 of the image processing apparatuses 111 and 112 acquires a file corresponding to the output file determined in step S2104 according to the data decoded in step S2103. In this regard, for example, the calculation processing unit 310 acquires either of the files “ALL.pdf”, “a01.pdf”, and “a02.pdf”.

In step S2106, the calculation processing unit 310 of the image processing apparatuses 111 and 112 prints (or displays) the file acquired in step S2105. Then, the processing ends.

As described above with reference to FIGS. 20A and 20B, the present exemplary embodiment embeds all the combination of part formats in the form generated first. Accordingly, the present exemplary embodiment can achieve the same effect as that of the first exemplary embodiment even when the image processing apparatuses 111 and 112 cannot communicate with the web application server 109.

That is, the present exemplary embodiment can output a form including only the information necessary to the user by changing the form to be output according to the user role. Form to be used when the form is scanned in an environment in which the image processing apparatuses 111 and 112 cannot communicate with the web application server 109, the present exemplary embodiment can prevent the user from executing a complicated operation in processing a work flow by changing the form to be output according to the combination of the user role and the work phase. In addition, with the above-described configuration, the present exemplary embodiment can prevent the leakage of significant information such as private information of the user. Moreover, the present exemplary embodiment can mask the private information that is not necessary to another user.

Note that it is also useful, in step S2106 (FIG. 21), if the dot pattern image area of the file acquired in step S2105 is written over the dot pattern image area of the scanned image extracted as the data area in step S2102 (i.e., embedded in the form) and the embedded dot pattern image area is printed.

Furthermore, if no dot pattern image area exists in the file acquired in step S2105, the following configuration is useful. That is, it is also useful if a dot pattern image area of the scanned image extracted in step S2102 as the data area is embedded in a blank area of the file acquired in step S2105 (or in an area to be printed on a back surface of a recording sheet in actual printing) and the embedded dot pattern image area is printed (or displayed).

With the above-described configuration, the present exemplary embodiment can output the form that includes only the information necessary to the user of a subsequent work phase by changing the visualizing area of the form according to the role of the user of the subsequent work phase by executing the processing in the flow chart in FIG. 21 with respect to the form printed in step S2106.

With the above-described configuration, the present exemplary embodiment can easily generate a form according to the work phase of the work flow executed according to one form (and the role of the user who processes the work flow) even when the image processing apparatuses 111 and 112 cannot communicate with the web application server 109.

As described above, exemplary embodiments of the present invention previously stores role-visualizing format correspondence information (map information), which defines the part format of the form to be visualized and output according to the user information (user role information) and embeds the stored map information in the data of the form to be output. Note that the format of the data to be embedded in the data of the form to be output is not limited to the above-described format. That is, when the data of the form to be output is printed on a sheet, any data can be used if the map information can be recognized by reading the printed form with the scanner. In this regard, more specifically, two-dimensional bar codes or dot patterns can be used. Thus, the present exemplary embodiment can process the work flow without losing the map information when the form is output on a sheet.

Note that it is also useful if information (information indicating the relationship between the user and a group, for example) similar to the role information according to the present exemplary embodiment is used instead thereof. Furthermore, the form format that can be applied to the present invention is not limited to the above-described form format. That is, any form format including a plurality of part formats can be used. In this regard, for example, a form file having a hierarchical structure can be applied to the present invention.

As described above, the present invention has the configuration in which in designating which form is to be output, a form is output according to the role based on a result of the determination as to which form is to be output according to the role by reading the above-described map information from the form printed on a sheet. Note that the processing flow is executed on the web application server 109 or the image processing apparatuses 111 and 112.

The above-described configuration of the present invention is useful in generating a new form based on an existing form that has been printed on a sheet and in outputting a form used by a user of a different role based on an existing form that has already been filled in and registered as a content.

Note that the structure of various data described above and the content thereof are not limited to those described above. Accordingly, the data can have an arbitrary appropriate structure and content according to the purpose of use thereof.

The exemplary embodiment of the present invention is as described above. The present invention can be implemented in a system, an apparatus, a method, a program, or a storage medium storing the program, for example. More specifically, the present invention can be applied to a system including a plurality of devices and to an apparatus that includes one device.

With the above-described configuration, the present exemplary embodiment can easily generate a form whose visualizing area therein has been changed according to the role information of a user who uses the form. In addition, the present exemplary embodiment can easily generate a hard copy of a form storing information for changing the visualizing area thereof according to the role information of the user who uses the form. Furthermore, the present exemplary embodiment can easily generate a form whose visualizing area has been changed according to the role information of another user who uses the form by using the hard copy of the form.

With the above-described configuration, the present exemplary embodiment can prevent the user from having a large number of items to fill in even when a plurality of users uses one form (or a form having a plurality of pages) and each of the users fills in the items of the form that each user is in charge of. Furthermore, with the above-described configuration, the present exemplary embodiment can prevent the leakage of private information of a user who has filled in a form to a subsequent user.

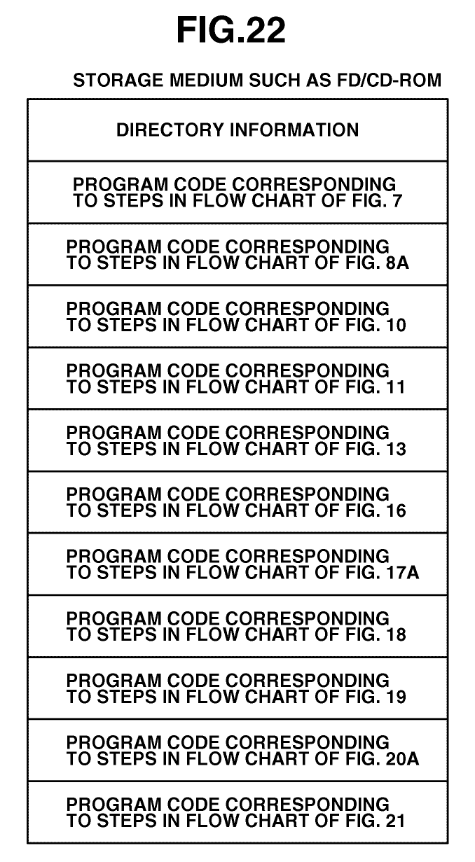

Hereinbelow, the configuration of a memory map of a storage medium storing various data processing programs that can be read by the information processing apparatus and the image processing apparatus according to an exemplary embodiment of the present invention will be described in detail with reference to a memory map illustrated in FIG. 22. FIG. 22 is a memory map illustrating an example of a storage medium (recording medium) storing various data processing programs that can be read by the information processing apparatus and the image processing apparatus according to an exemplary embodiment of the present invention.

Although not illustrated in FIG. 22, information for managing the programs stored in the storage medium, such as version information and information concerning the creator of a program, for example, can be stored in the storage medium. In addition, information that depends on an operating system (OS) of an apparatus that reads the program, such as an icon for identifying and displaying the program, can be stored in the storage medium.

In addition, data that is subordinate to the various programs is also managed in a directory of the storage medium. In addition, a program for installing the various programs on a computer can be stored in the storage medium. In addition, in the case where a program to be installed is compressed, a program for decompressing the compressed program can be stored in the storage medium.

In addition, the functions according to the above-described exemplary embodiments illustrated in FIGS. 7, 8A, 10, 11, 13, 16, 17A, 18, 19, 20A, and 21 can be implemented by a host computer using a program that is externally installed. In this case, the present invention is applied to the case where a group of information including a program is supplied to an output device from a storage medium, such as a CD-ROM, a flash memory, and a floppy disk (FD) or from an external storage medium through a network.

The present invention can also be achieved by providing a system or an apparatus with a storage medium storing program code of software implementing the functions of the embodiments and by reading and executing the program code stored in the storage medium with a computer of the system or the apparatus (a CPU or a micro processing unit (MPU)).

In this case, the program code itself, which is read from the storage medium, implements the functions of the embodiments described above, and accordingly, the storage medium storing the program code constitutes the present invention.

Accordingly, the program can be configured in any form, such as object code, a program executed by an interpreter, and script data supplied to an OS.

As the storage medium for supplying such program code, a flexible disk, a hard disk, an optical disk, a magneto-optical disk (MO), a compact disc-read only memory (CD-ROM), a CD-recordable (CD-R), a CD-rewritable (CD-RW), a magnetic tape, a nonvolatile memory card, a ROM, and a digital versatile disc (DVD), for example, can be used.

In this case, the program code itself, which is read from the storage medium, implements the function of the embodiments mentioned above, and accordingly, the storage medium storing the program code constitutes the present invention.

The above program can also be supplied by connecting to a web site on the Internet by using a browser of a client computer and by downloading the program from the web site to a storage medium such as a hard disk. In addition, the above program can also be supplied by downloading a compressed file that includes an automatic installation function from the web site to a storage medium such as a hard disk. The functions of the above embodiments can also be implemented by dividing the program code into a plurality of files and downloading each divided file from different web sites. That is, a World Wide Web (WWW) server and a file transfer protocol (ftp) server for allowing a plurality of users to download the program file for implementing the functional processing configure the present invention.

In addition, the above program can also be supplied by distributing a storage medium such as a CD-ROM and the like which stores the program according to the present invention after an encryption thereof; by allowing the user who is qualified for a prescribed condition to download key information for decoding the encryption from the web site via the Internet; and by executing and installing in the computer the encrypted program code by using the key information.

In addition, the functions according to the embodiments described above can be implemented not only by executing the program code read by the computer, but also implemented by the processing in which an OS or the like carries out a part of or the whole of the actual processing based on an instruction given by the program code.

Further, in another aspect of the embodiment of the present invention, after the program code read from the storage medium is written in a memory provided in a function expansion board inserted in a computer or a function expansion unit connected to the computer, a CPU and the like provided in the function expansion board or the function expansion unit carries out a part of or the whole of the processing to implement the functions of the embodiments described above.

In addition, the present invention can be applied to a system including a plurality of devices and to an apparatus that includes one device. Furthermore, the present invention can be implemented by supplying a system or an apparatus with a program. In this case, by reading the storage medium that stores a program described by software that can implement the present invention with the system or the apparatus, the system or the apparatus can implement the present invention.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2008-058167 filed Mar. 7, 2008, which is hereby incorporated by reference herein in its entirety.

What is claimed is:

1. An information processing apparatus comprising:
a first storage unit configured to store a plurality of part formats and a form format including a combination of the part formats;
a second storage unit configured to store role-visualizing format correspondence information, which defines a part format included in the form format, which is to be visualized and output, with respect to role information about each user;
a determination unit configured to, in response to an instruction for outputting a form corresponding to the form format, determine which part format is to be visualized and output according to role information of a designated user based on the role-visualizing format correspondence information;
an embedding data generation unit configured to generate data to be embedded including data generated by encoding the role-visualizing format correspondence information according to a specific coding system; and
a form output data generation unit configured to generate form output data by embedding the data generated by the embedding data generation unit in a format generated by merging the part formats to be visualized and output determined by the determination unit.

2. The information processing apparatus according to claim 1, wherein the role-visualizing format correspondence information includes defining a part format included in the form format to be visualized and output with respect to each combination of the role information and a work phase of a work flow, and
wherein the determination unit is configured to determine the part format to be visualized and output according to a combination of the role information of a user and a designated work phase of a work flow based on the role-visualizing format correspondence information.

3. An information processing apparatus comprising:
a first storage unit configured to store a plurality of part formats and a form format including a combination of the part formats;
a second storage unit configured to store role-visualizing format correspondence information, which defines a part format included in the form format, which is to be visualized and output, with respect to role information about each user;
a determination unit configured to, in response to an instruction for outputting a form corresponding to the form format, determine which part format is to be visualized and output according to role information of a designated user based on the role-visualizing format correspondence information;
an embedding data generation unit configured to generate, according to the role-visualizing format correspondence information, form output data corresponding to a form including a combination of part formats to be visualized and output with respect to each role information, to generate role-output data correspondence information indicating a correspondence between the generated form output data and each role information, and to generate data to be embedded including data generated by encoding the form output data and the role-output data correspondence information according to a specific coding system; and
a form output data generation unit configured to generate form output data by embedding the data generated by the embedding data generation unit in a format generated by merging the part formats to be visualized and output determined by the determination unit.

4. The information processing apparatus according to claim 3, wherein the role-visualizing format correspondence information includes defining a part format included in the form format to be visualized and output with respect to each combination of the role information and a work phase of a work flow,
wherein the determination unit is configured to determine the part format to be visualized and output according to a combination of designated role information of a user and a designated work phase of a work flow based on the role-visualizing format correspondence information, and
wherein the embedding data generation unit is configured to generate, according to the role-visualizing format correspondence information, form output data corresponding to a form including a combination of part formats to be visualized and output with respect to each combination of the role information and the work phase, to generate role-output data correspondence information indicating a correspondence between the generated form output data and each combination of the role information and the work phase, and to generate data to be embedded including data generated by encoding the form output data and the role-output data correspondence information according to the specific coding system.

5. The information processing apparatus according to claim 1, wherein the specific coding system includes a dot pattern system and two-dimensional bar code system.

6. An image processing apparatus capable of communicating with an information processing apparatus that is configured to store a form format including a plurality of part formats and a form format including a combination of the part formats and to generate form output data by merging the part formats included in the form format, the image processing apparatus comprising:
a scanning unit configured to read image data from a sheet on which a form is printed, the form including embedded data generated by encoding role-visualizing format correspondence information, which defines a part format to be visualized and output included in the form format with respect to role information about each user, according to a specific coding system;
a transmission unit configured to transmit the image data read by the scanning unit and designated user information to the information processing apparatus;
a receiving unit configured to receive form output data from the information processing apparatus, wherein, in response to transmission from the transmission unit, the information processing apparatus acquires the role-visualizing format correspondence information by decoding data included in the image data and encoded according to the specific coding system, determines the part format to be visualized and output according to the role information corresponding to the user information based on the role-visualizing format correspondence information, and generates the form output data based on the determined part format to be visualized and output; and
an output unit configured to output a form based on the form output data received by the receiving unit.

7. The image processing apparatus according to claim 6, wherein the role-visualizing format correspondence information includes defining a part format included in the form format to be visualized and output with respect to each combination of the role information and a work phase of a work flow,
wherein the transmission unit is configured to transmit the image data read by the scanning unit, the designated user information, and designated work flow information to the information processing apparatus;
wherein the receiving unit is configured to receive the form output data from the information processing apparatus, wherein, in response to transmission from the transmission unit, the information processing apparatus acquires the role-visualizing format correspondence information by decoding data included in the image data and encoded according to the specific coding system, determines the part format to be visualized and output according to a combination of the role information corresponding to the user information and a work phase of a work flow corresponding to the work flow information based on the role-visualizing format correspondence information, and generates the form output data based on the determined part format to be visualized and output.

8. An image processing apparatus comprising:
a scanning unit configured to read image data from a sheet on which a form is printed, the form including embedded plural-form output data and data generated by encoding role-output data correspondence information, which indicates a correspondence between role information about each user and the form output data, according to a specific coding system;
an acquisition unit configured to acquire the form output data and the role-output data correspondence information by acquiring and decoding the data included in the image data read by the scanning unit and encoded according to the specific coding system;
a determination unit configured to determine the form output data corresponding to designated role information about a user based on the role-output data correspondence information; and
an output unit configured to output a form based on the form output data determined by the determination unit.

9. The image processing apparatus according to claim 8, wherein the output unit is configured to output a form by embedding the data encoded according to the specific coding system in the form output data determined by the determination unit.

10. The image processing apparatus according to claim 8, wherein the role-output data correspondence information indicates a correspondence between the form output data and each combination of the role information and a work phase of a work flow, and
wherein the determination unit is configured to determine the form output data corresponding to a combination of designated role information about a user and a designated work phase of a work flow based on the role-output data correspondence information.

11. The image processing apparatus according to claim 6, wherein the specific coding system includes a dot pattern system and a two-dimensional bar code system.

12. A method for controlling an information processing apparatus including a first storage unit configured to store a plurality of part formats and a form format including a combination of the part formats and a second storage unit configured to store role-visualizing format correspondence information, which defines a part format included in the form format, which is to be visualized and output, with respect to role information about each user, the method comprising:
in response to an instruction for outputting a form corresponding to the form format, determining which part format is to be visualized and output according to role information of a designated user based on the role-visualizing format correspondence information;
generating data to be embedded including data generated by encoding the role-visualizing format correspondence information according to a specific coding system; and
generating form output data by embedding the generated data in a format generated by merging the determined part formats to be visualized and output.

13. The method according to claim 12, wherein the role-visualizing format correspondence information includes defining a part format included in the form format to be visualized and output with respect to each combination of the role information and a work phase of a work flow, and
wherein the method further comprises determining the part format to be visualized and output according to a combination of the role information of a user and a designated work phase of a work flow based on the role-visualizing format correspondence information.

14. A method for controlling an information processing apparatus including a first storage unit configured to store a plurality of part formats and a form format including a combination of the part formats and a second storage unit configured to store role-visualizing format correspondence information, which defines a part format included in the form format, which is to be visualized and output, with respect to role information about each user, the method comprising:
in response to an instruction for outputting a form corresponding to the form format, determining which part format is to be visualized and output according to role information of a designated user based on the role-visualizing format correspondence information;
generating, according to the role-visualizing format correspondence information, form output data corresponding to a form including a combination of part formats to be visualized and output with respect to each role information, generating role-output data correspondence information indicating a correspondence between the generated form output data and each role information, and generating data to be embedded including data generated by encoding the form output data and the role-output data correspondence information according to a specific coding system; and
generating form output data by embedding the generated data in a format generated by merging the determined part formats to be visualized and output.

15. The method according to claim 14, wherein the role-visualizing format correspondence information includes defining a part format included in the form format to be visualized and output with respect to each combination of the role information and a work phase of a work flow, and
wherein the method further comprises:
determining the part format to be visualized and output according to a combination of designated role information of a user and a designated work phase of a work flow based on the role-visualizing format correspondence information; and
generating, according to the role-visualizing format correspondence information, form output data corresponding to a form including a combination of part formats to be visualized and output with respect to each combination of the role information and the work phase, generating role-output data correspondence information indicating a correspondence between the generated form output data and each combination of the role information and the work phase, and generating data to be embedded including data generated by encoding the form output data and the role-output data correspondence information according to the specific coding system.

16. The method according to claim 12, wherein the specific coding system includes a dot pattern system and two-dimensional bar code system.

17. A method for controlling an image processing apparatus capable of communicating with an information processing apparatus that is configured to store a form format including a plurality of part formats and a form format including a combination of the part formats and to generate form output data by merging the part formats included in the form format, the method comprising:
reading image data from a sheet on which a form is printed, the form including embedded data generated by encoding role-visualizing format correspondence information, which defines a part format to be visualized and output included in the form format with respect to role information about each user, according to a specific coding system;
transmitting the read image data and designated user information to the information processing apparatus;
receiving form output data from the information processing apparatus, wherein, in response to transmission, the information processing apparatus acquires the role-visualizing format correspondence information by decoding data included in the image data and encoded according to the specific coding system, determines the part format to be visualized and output according to the role information corresponding to the user information based on the role-visualizing format correspondence information, and generates the form output data based on the determined part format to be visualized and output; and
outputting a form based on the received form output data.

18. The method according to claim 17, wherein the role-visualizing format correspondence information including defining a part format included in the form format to be visualized and output with respect to each combination of the role information and a work phase of a work flow, and
wherein the method further comprises:
transmitting the read image data, the designated user information, and designated work flow information to the information processing apparatus; and
receiving the form output data from the information processing apparatus, wherein, in response to transmission, the information processing apparatus acquires the role-visualizing format correspondence information by decoding data included in the image data and encoded according to the specific coding system, determines the part format to be visualized and output according to a combination of the role information corresponding to the user information and a work phase of a work flow corresponding to the work flow information based on the role-visualizing format correspondence information, and generates the form output data based on the determined part format to be visualized and output.

19. A method comprising:
read image data from a sheet on which a form is printed, the form including embedded plural-form output data and data generated by encoding role-output data correspondence information, which indicates a correspondence between role information about each user and the form output data, according to a specific coding system;
acquiring the form output data and the role-output data correspondence information by acquiring and decoding the data included in the read image data and encoded according to the specific coding system;
determining the form output data corresponding to designated role information about a user based on the role-output data correspondence information; and
outputting a form based on the determined form output data.

20. The method according to claim 19, further comprising outputting a form by embedding the data encoded according to the specific coding system in the determined form output data.

21. The method according to claim 19, wherein the role-output data correspondence information indicates a correspondence between the form output data and each combination of the role information and a work phase of a work flow, and
wherein the method further comprises determining the form output data corresponding to a combination of designated role information about a user and a designated work phase of a work flow based on the role-output data correspondence information.

22. The method according to claim 17, wherein the specific coding system includes a dot pattern system and a two-dimensional bar code system.
